(19) United States
(12) Patent Application Publication
(10) Pub. No.: US 2026/0134373 A1
(43) Pub. Date: May 14, 2026

(54) Emerging Risk Event Detection and Evaluation

(71) Applicant: Aon Global Operations, SE, Singapore Branch, Singapore (SG)

(72) Inventors: Dylan Butler, Dublin 1 (IE); Shane Egan, Dublin 1 (IE); Saikrishna Javvadi, Dublin 1 (IE); Martin McGovern, Dublin 1 (IE); Joanne Daly, Dublin 1 (IE); Jatin Metar, Dublin 1 (IE); Dev Pratap Singh, Saharanpur (IN)

(73) Assignee: Aon Global Operations, SE, Singapore Branch, Singapore (SG)

(21) Appl. No.: 19/441,258

(22) Filed: Jan. 6, 2026

Related U.S. Application Data
(63) Continuation-in-part of application No. 19/263,119, filed on Jul. 8, 2025.
(60) Provisional application No. 63/668,929, filed on Jul. 9, 2024.

(51) Int. Cl. G06Q 10/0635; G06Q 30/0201

(52) U.S. Cl. CPC G06Q 10/0635; G06Q 30/0201

(57) ABSTRACT

In an illustrative embodiment, a system for monitoring secondary impact to an organization due to a risk event includes gathering publications relevant to the organization, analyzing text contents of each publication in view of an emerging risk taxonomy to identify event data values including a start date and a location, and performing entity valuation monitoring to track potential risk impact by collecting an initial financial snapshot on a first date, multiple days after the initial financial snapshot, collecting at least one additional financial snapshot, analyzing the additional financial snapshot(s) in view of the initial financial snapshot to determine an organizational financial trend over a time period spanning from the first date to the second date, determining at least one comparison financial trend over the time period, and adjusting the organizational financial trend in view of the comparison financial trend(s).

### RELATED APPLICATIONS

The present application is a continuation-in-part of and claims priority to U.S. patent application Ser. No. 19/263,119 entitled “Emerging Risk Event Detection and Evaluation” and filed Jul. 8, 2025, which claims the benefit of U.S. Provisional Ser. No. 63/668,929 entitled “Emerging Risk Event Detection and Evaluation” and filed Jul. 9, 2024. Each above-identified application is hereby incorporated by reference in its entirety.

### BACKGROUND

Emerging risks are rapidly evolving, complex threats that lack the necessary level of understanding and/or established risk mitigation options to effectively prepare for their impact. Examples of emerging risks include trends in wildfire outbreaks, cybersecurity attacks, and health pandemics. Emerging risks can have unprecedented volatility in terms of frequency of events and/or severity of impact. In addition, as these risks are emerging in an era of unparalleled globalization, they are much more interconnected and co-dependent than established risks. These factors make it critical for business organizations, communities, and governments to understand their exposure to these risks and to optimize their risk mitigation accordingly. Emerging risk will change the risk landscape in profound ways. As the understanding of these risks is still relatively immature, understanding of their key risk drivers is limited.

The inventors recognized the need to proactively derive key risk drivers for emerging risks from evolving reports gathered through global publication sources to enhance risk understanding as risk events occur.

Additionally, a subset of these emerging risks leave organizations vulnerable to secondary risk, such as supply chain risk and/or a reputational risk. The COVID pandemic, in particular, brought international attention to the impact emerging risk can have on global supply chains. Additionally, although reputation may be a subjective concept, reputational risk can lead to very real financial losses to organizations, including, in some examples, a loss of client or customer base, a drop in employee morale / increase in employee turnover, and/or loss of financial backing (e.g., drop in stock price, loss of private investors, etc.).

The inventors recognized the need to evaluate potential impact of secondary risks spawned by emerging risk events. Through acknowledging the likelihood of secondary risk stemming from certain emerging risks, an organization may take steps to mitigate the risk potential.

### SUMMARY OF ILLUSTRATIVE EMBODIMENTS

In one aspect, the present disclosure relates to systems and methods for discovering and recording global risk events through automated analysis of publications gathered from global media sources. The publications, for example, may be collected from network-accessible media publication databases. One or more application programming interfaces (APIs) may be used to communicate queries to extract a relevant portion of the publication collection. For example, publications may be extracted based at least in part on entity information including one or more features descriptive of an organization. The entity features may include, in some examples, an organization name, a geographic region, and/or an industry. The publications may include unstructured natural language data in the form of news releases, articles, and other media descriptions of evolving news events.

In some embodiments, the systems and methods for discovering and recording global risk events are configured to extract structured risk-specific information from the unstructured natural language data of a set of media publications. The automated extraction, for example, may provide a technical solution to the technical problem of organizing unstructured natural language data to derive specific features relevant to understanding concepts captured in media coverage of evolving news stories regarding emerging risk events. The automated extraction, in illustration, may be configured to extract the who, what, when, where, and why specific to various types of emerging risk events. One or more artificial intelligence (AI) networks, such as a generative large language model (LLM) (e.g., such as ChatGPT), may be trained and/or fine-tuned to extract unstructured text portions defined using a risk data schema defining types and relationships between event details.

In some embodiments, the systems and methods for discovering and recording global risk events are configured to, prior to extracting the structured risk-specific information from the unstructured natural language data, format the unstructured natural language data as vector formatted event details stored to a vector database. The vector formatting, for example, may capture relationships between the named-entities recognized within each publication and unstructured natural language contents surrounding the recognized named-entities. The vector formatting may supply the AI networks with consistently formatted publication data, improving analysis output. Further, the vector formatting may reduce storage requirements for storing the publication data for analysis.

In one aspect, the present disclosure relates to a data model architecture for storing information gleaned from publications gathered from global media sources in a manner supporting detailed analysis for deriving key risk factors. The data model architecture, for example, may include vector-formatted publication contents that are tagged or labeled based on named-entity recognition. The labeling, for example, may be performed in part based on a risk event taxonomy that may be customized to a particular type of emerging risk event.

In one aspect, the present disclosure relates to systems and methods for objectively quantifying the impact of reputational risk associated with emerging risk events. Emerging risk events commonly represent uninsurable or partially insurable risks due to lack of effective risk transfer products and/or a paucity of risk understanding. By objectively quantifying the impact of reputational risk, the systems and methods described herein may track trends in reputational impact, compare behaviors of organizations impacted by various types of emerging risks to derive successful mitigation factors, and/or discover key risk drivers for downstream reputational harm.

Reputational risk impact, in some embodiments, is objectively quantified by determining a longer-term financial impact to an organization resulting from the emerging risk event. A financial snapshot representing the financial status of the organization may be obtained at the point at which public discussion of the emerging risk event is first identified. The financial snapshot, for example, may include at least one stock price. Further, financial data regarding the market in general may be collected for comparative purposes. The financial data may include one or more stock indices or other financial bellwether. The financial data, for example, may represent a geography, industry, and/or business line of the effected organization. The snapshot may be compared to one or more future snapshots to determine whether a change in value of the effected organization deviates from a change in value of the general market status (e.g., stock index, geographical representation, industry representation, business line representation, etc.). The one or more future snapshots, in one example, may be captured at predetermined intervals (e.g., one week, two weeks, three weeks, one month, six weeks, eight weeks, etc.). In another example, at least one of the future snapshots may be captured based on a status of the publicity related to the emerging risk event (e.g., new publications drop to a predetermined percentage of a spike level of publications per time period such as per day).

In some embodiments, publications may be monitored over time for a “spike” in the story line, representing a point at which information has been widely distributed and detailed analysis of the event as it unfolded are available in a portion of the publications. Concurrent with and/or after the spike, publications may be monitored to identify one or more responses by the effected organization to the event. In illustration, public announcement, mitigation techniques, disclosure and assistance of affected partners/clients/customers, and/or additional activities (e.g., shutting down systems, paying ransom to regain data access, etc.), may be described within a portion of the publications that follow the event. The responses may be analyzed in view of the financial impact to identify one or more successful strategies for mitigating reputational impact.

In one aspect, the present disclosure relates to systems and methods for consolidating emerging risk data and presenting detailed analysis of the potential impact of various emerging risks. The presentation may be customized in light of an entity's (e.g., business, community, government, or other organization) unique risk factors. In another example, the presentation may include a consolidated analysis of many emerging risk events that occurred over a period of time (e.g., one month, one quarter, one year, multiple years, etc.).

In some embodiments, the presentation represents a consolidation of at least one type of emerging risk event and/or multiple types of emerging risk events occurring in a particular geographic region, to a particular business sector, and/or to a particular industry. The presentation, for example, may include graphic illustrations regarding relative and/or absolute quantities of emerging risk events by type, geographical region, sector, and/or industry. In another example, the presentation may include value impact comparisons (e.g., absolute and/or relative) demonstrating differentiation in value (e.g., stock price, privately disclosed valuation, etc.) between the time of the impact of the emerging risk event (e.g., prior to or concurrent with public disclosure of the emerging risk event) and after a period of time has elapsed since the risk event (e.g., predetermined time span, time span based on ongoing publicity regarding the emerging risk event, etc.). In a further example, the presentation may include identifying a ranking of the top types of emerging risk events by frequency (e.g., types of natural disaster, product recall, type of cybersecurity event, etc.). Other presentation options are possible.

The foregoing general description of the illustrative embodiments and the following detailed description thereof provide mere examples of various aspects of the teachings of this disclosure and are not restrictive.

### BRIEF DESCRIPTION OF THE DRAWINGS

The accompanying drawings, which are incorporated in and constitute a part of the specification, illustrate one or more embodiments and, together with the description, explain these embodiments. The accompanying drawings have not necessarily been drawn to scale. Any values dimensions illustrated in the accompanying graphs and figures are for illustration purposes only and may or may not represent actual or preferred values or dimensions. In the drawings:

FIG. 1A is a flow diagram of an example process for identifying emerging risk events;

FIG. 1B is a flow diagram of an example process for gathering entity financial information corresponding to emerging risk events;

FIG. 2 is a flow chart of an example method for capturing and analyzing emerging risk event data;

FIG. 3 is a flow diagram of an example process for assessing risk events for potential secondary risk impact;

FIG. 4A through FIG. 4C illustrate a flow chart of an example method for identifying and tracking emerging risk events;

FIG. 5 is a block diagram of example data structures related to emerging risk events;

FIG. 6 is a flow chart of an example method for performing historic trend analyses on reputational risk event data;

FIG. 7A through FIG. 7C illustrate example graphical user interfaces presenting historical analyses of reputational risk events;

FIG. 8A and FIG. 8B illustrate example graphical user interfaces presenting regional analyses of emerging risk events by event type;

FIG. 9 illustrates an example graphical user interface presenting regional analysis of natural catastrophic risk events; and

FIG. 10 is an example data arrangement illustrating a set of categories of emerging risk.

### DETAILED DESCRIPTION OF ILLUSTRATIVE EMBODIMENTS

The description set forth below in connection with the coordinating drawings is intended to be a description of various, illustrative embodiments of the disclosed subject matter. Specific features and functionalities are described in connection with each illustrative embodiment; however, it will be apparent to those skilled in the art that the disclosed embodiments may be practiced without each of those specific features and functionalities.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments. Further, it is intended that embodiments of the disclosed subject matter cover modifications and variations thereof.

As used in the specification and the appended claims, the singular forms “a,” “an,” and “the” include plural referents unless the context expressly dictates otherwise. That is, unless expressly specified otherwise, as used herein the words “a,” “an,” “the,” and the like carry the meaning of “one or more.” Additionally, it is to be understood that terms such as “left,” “right,” “top,” “bottom,” “front,” “rear,” “side,” “height,” “length,” “width,” “upper,” “lower,” “interior,” “exterior,” “inner,” “outer,” and the like that may be used herein merely describe points of reference and do not necessarily limit embodiments of the present disclosure to any particular orientation or configuration. Furthermore, terms such as “first,” “second,” “third,” etc., merely identify one of a number of portions, components, steps, operations, functions, and/or points of reference as disclosed herein, and likewise do not necessarily limit embodiments of the present disclosure to any particular configuration or orientation.

Further, the terms “approximately,” “about,” “proximate,” “minor variation,” and similar terms generally refer to ranges that include the identified value within some margin, such as, in some examples, 20%, 10%, or 5% in certain embodiments, as well as any values therebetween.

All of the functionalities described in connection with one embodiment are intended to be applicable to the additional embodiments described below except where expressly stated or where the feature or function is incompatible with the additional embodiments. For example, where a given feature or function is expressly described in connection with one embodiment but not expressly mentioned in connection with an alternative embodiment, it should be understood that the inventors intend that that feature or function may be deployed, utilized or implemented in connection with the alternative embodiment unless the feature or function is incompatible with the alternative embodiment.

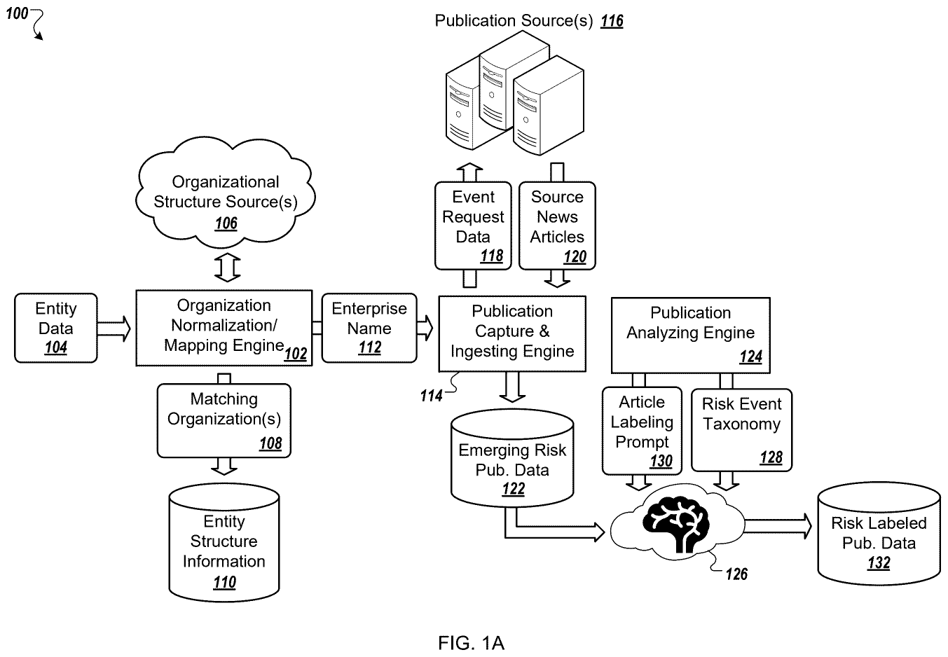

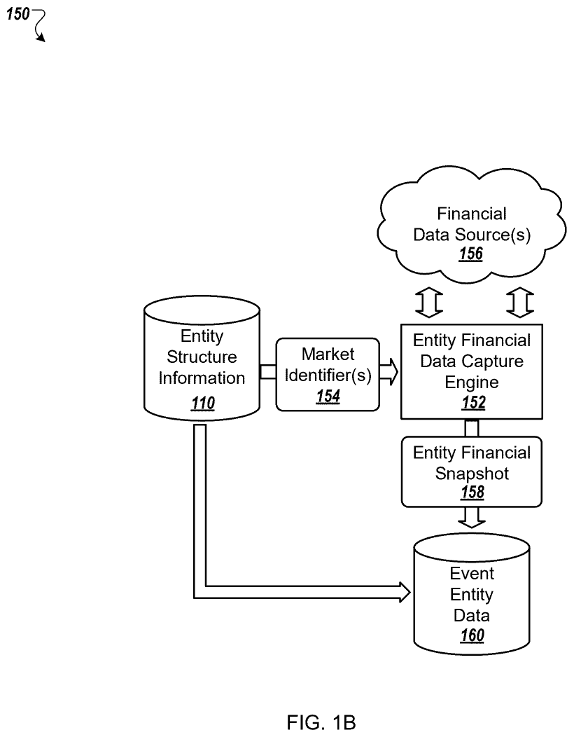

Turning to FIG. 1A, a flow diagram illustrates a process 100 for collecting information regarding emerging risks from media content, and distilling, from the information, data relevant to individual emerging risk events. The process flow 100 may be performed on a periodic basis to identify risk events associated with one or more entities. In example, the collection of newly published source news articles may be performed on a first periodic basis (e.g., based on availability of new material for each network-available news source, based on a customized user setting, etc.). The periodic bases may include, in some examples, daily, weekly, monthly, and/or quarterly. In another example, a watch may be placed for new publications related one or more target entities (e.g., corporations or other organizations). The various engines of the process 100, in some embodiments, are configured as software routines or processes (e.g., at least a portion of a software program) coded as instructions for executing on processing circuitry, such as one or more processors. Certain engines or operations performed by certain engines, in some embodiments, are configured as hardware logic (e.g., hardware-based operations) hard-coded or programmed into processing circuitry, such as, in some examples, a programmable logic chip or other programmable logic device, an application-specific integrated circuit (ASIC), or a customized processor device.

In some implementations, an organization normalization/mapping engine 102 obtains entity data 104 for matching to one or more organizations, such as a corporate hierarchy. The entity data may include, in some examples, an entity name, an entity type (e.g., corporation, LLC, non-profit, educational organization, etc.), an entity location (e.g., at least a country, a country and city, an address, etc.), and/or another entity identifier (e.g., stock ticker, International Securities Identification Number (ISIN), etc.).

The organization normalization/mapping engine 102, in some implementations, normalizes information contained in the entity data 104. In one example, address information may be standardized (e.g., United States +4 zip code, extend Rd./Ln./St. etc. to full terms, etc.). Abbreviations for state and/or country may be normalized, or a country may be extracted from other information (e.g., a country code within a telephone number). In a further example, an organization name may be matched to its full title (e.g., Microsoft may be extended to “Microsoft Corporation.” The normalizing, for example, may be performed based in part on natural language processing (NLP) analysis of portions of the entity data 104. In some embodiments, the organization normalization/mapping engine 102 accesses one or more “firmographics” sources to cross-reference entity details relative to the supplied entity data 104. The “firmographics,” in illustration, may contain a portion of the details collected in corporate profiles such as those supplied by Bloomberg. In an illustrative example, the organization normalizing/mapping engine 102 may determine, based on the supplied entity data 104, normalized information for at least an entity name and an entity country.

In some implementations, the organization normalization/mapping engine 102 maps the normalized entity data 104 to one or more organizations (e.g., an organizational hierarchy or other relational structure, such as an acquired or otherwise renamed entity being mapped to current organization information). The organization normalization/mapping engine 102, for example, may cross-reference a portion of the normalized entity date with one or more organizational structure sources 106, such as one or more external databases of corporate structural relationships. The normalized entity data, for example, may be provided to each organizational structure source 106 to obtain response data including one or more matching organizations 108. In the event of an entity having multiple organizational relationships, the response may include a relationship architecture. The relationship structure may be stored, for example, as entity structure information 110. Each matching organization 108, in some embodiments, is provided along with profile data such as, in some examples, an address of headquarters, names and locations of one or more subsidiaries, names and locations of one or more divisions, names and locations of one or more parent organizations, prior names and/or prior locations (e.g., pre-acquisition or merger, etc.), and/or names and locations of affiliated partners. In some embodiments, the matching organization(s) 108 data includes one or more financial identifiers such as, in some examples, stock ticker information, international securities identification number (ISIN) code, and/or financial index membership. Each matching organization 108, further, may be classified according to one or more of geography, industry, and/or sector.

Using the matching organizations 108, in some implementations, the organization normalization/mapping engine 102 selects an enterprise name 112 representative of the original entity data 104 and useful in researching information regarding the entity. In some examples, the selected name may be selected based at least in part on a publicly recognized organization rather than a controlling entity that may lack household recognition, a stock exchange-traded organization rather than its subsidiary, and/or a name most relevant to a designated geographic region received within the entity data 104. At least the enterprise name 112 may be provided for publication search. Additionally, in some embodiments, an industry, geographic region, sector, and/or product information may be provided along with the enterprise name 112 for use in searching.

In some implementations, a publication capture and ingesting engine 114 queries one or more publication sources 116 using the enterprise name 112. The one or more queries, in some examples, may include database queries to one or more databases, API calls to one or more third party data collection services (e.g., news publication aggregators), and/or engineered prompts to one or more artificial intelligence models. Each query may be provided, for example, as event request data 118. The event request data 118 may specify publications of interest such as, in some examples, one or more news sources (e.g., trusted authorities), a timeframe, and/or a context (e.g., related to, rather than just mentioning, the enterprise name 112). The publication sources 116, for example, may include and/or have access to breaking news sources such as, in some examples, newspapers, electronic magazines, journal publications, and/or other electronic news circulations containing information regarding risk events. The news sources accessed via the publication sources 116 may vary in type and geographic breadth, in some embodiments, based on the entity data 104 (e.g., geographic region) and/or other factors such as client specifications regarding preferred or trusted authorities. The publication capture & ingesting engine 114 may collect publications originating from tens of thousands of news outlets in hundreds of countries around the world.

The publication source(s) 116 may return source news articles 120 pertaining to at least the enterprise name 112. The source news articles 120 may further include metadata (e.g., tags, labels, etc.) qualifying contents of each of the source news articles 120. The metadata, in some examples, may include a context (e.g., cybersecurity, natural disaster, labor, etc.), a summary (e.g., the gist of the article), an industry, one or more additional entities, and/or a grouping (e.g., a cluster of articles appearing to pertain to the same event). Each of the source news articles, in further examples, may include a unique data item identifier, a publication source identifier (e.g., news outlet, brokerage report, governmental report, etc.), a content source identifier (e.g., one of the publication sources 116), a title, a body of text, one or more images, image metadata, a date and/or timestamp, and/or a category (e.g., a news section category such as U.S. politics, business, world events, etc.).

The publication capture and ingesting engine 114, in some implementations, stores the source news articles 120 to an emerging risk publication data store 122. The publication capture and ingesting engine 114 may store the source news articles 120 in a tabular format including a select portion of the descriptive information (e.g., metadata such as publication source, timestamp, category, etc.), such that the information retained is consistent, concise, and capable of efficient extraction for later use. The emerging risk publication data store 122, for example, may include a remotely managed data repository having storage enforced by cluster policies established to manage both structured data (e.g., the metadata) and unstructured data (e.g., body text). The data, for example, may be collected into a set of digital storage containers organized to initially group information based in part on certain metadata fields (e.g., date information, classification information, etc.). The data of the risk emerging risk publication data store 122, in some embodiments, is accessible via database query mechanisms. In illustration, the publication capture and ingesting engine 114 may load portions of each of the source news article 120 to a corresponding location in a database structure, such as article body, title, and related article grouping (e.g., cluster identifier).

The publication capture and ingesting engine 114 may capture (from the metadata) and/or generate, in one example, summary statistics related to each article, such as article length, a total word count, and/or a word count within the title.

In some embodiments, the publication capture and ingesting engine 114 generates summary statistics across portions of the captured publications, such as a cluster size of each grouping of similar articles and/or counts of articles mentioning one or more additional organizations. The summary statistics may be used, for example, in objectively evaluating the severity or scope of an emerging risk event.

The publication capture and ingesting engine 114, in some implementations, filters the source news articles 120 to reduce a quantity of the content stored as the emerging risk publication data of the data store 122. For example, the publication capture and ingesting engine 114 may remove duplicate articles (e.g., based on title and body word count, based on matching contents to those already stored to the data store 122, etc.), and/or remove unusable articles lacking a minimal depth of information (e.g., a minimum length of body text and/or a minimum title). In other embodiments, the publication source(s) 116 may be instructed (e.g., within the event request data 118) to ignore any articles lacking sufficient depth and/or to remove duplicates.

In some implementations, a publication analyzing engine 124 prompts one or more artificial intelligence networks 126 to organize the source news articles 120 stored to the emerging risk publication data store 122 according to at least one risk event taxonomy 128. The publication analyzing engine 124, for example, may prepare at least one article labeling prompt 130 instructing the AI network(s) 126 to analyze relationships among the emerging risk publication data 122 and to organize the emerging risk publication data 122 according to internal relationships (e.g., the metadata, database labels, etc.) as well as the risk event taxonomy 128.

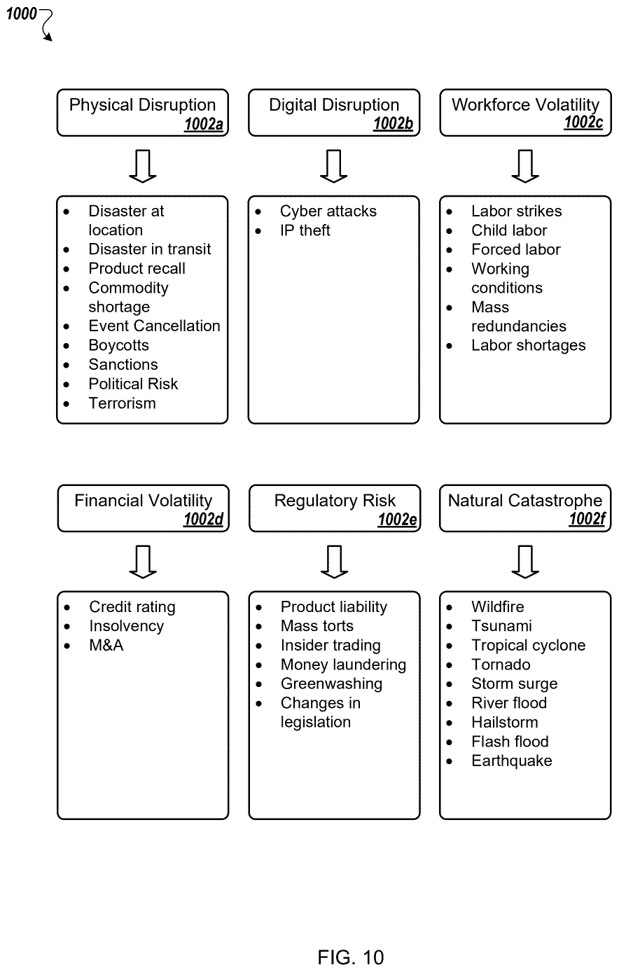

The risk event taxonomy 128, in some embodiments, defines parameters for identifying and quantifying articles within the source news articles 120 that relate to a particular type of risk event. The risk event taxonomy 128 may include terms and relationships between terms that capture discussions related to a particular style of risk event. The topic risk events, in some illustrative examples, may include one or more of the risk events identified in the risk event categories 1002a-f of FIG. 10. For example, the topic risk event may relate to a physical disruption event 1002a (e.g., disaster at location, disaster in transit, product recall, commodity shortage, event cancellation, boycott, sanction, political risk, terrorism, etc.), a digital disruption event 1002b (e.g., cyber attack, intellectual property theft, etc.), a workforce volatility event 1002c (e.g., labor strike, child labor, forced labor, working conditions, mass redundancy, labor shortage, etc.), a financial volatility event 1002d (e.g., credit rating, insolvency, M&A, etc.), a regulatory risk event 1002e (e.g., product liability, mass tort, insider trading, money laundering, greenwashing, change in legislation, etc.), and/or a natural catastrophe event 1002f (e.g., wildfire, tsunami, tropical cyclone, tornado, storm surge, river flood, hailstorm, flash flood, earthquake, etc.). Additional risk events may include climate events (e.g., permafrost thaws, significant glacial movement, coral reef demise, significant migratory disruptions, etc.), health risks (e.g., pandemics, biological warfare, environmental contaminants, etc.), particular cyber attack risks (e.g., data breaches, phishing attacks, ransomware attacks, malware, etc.), and/or geopolitical risks (e.g., significant currency valuation fluctuations, civil conflict/war, international conflict/war, political polarization, governmental assassination, national debt crises, etc.).

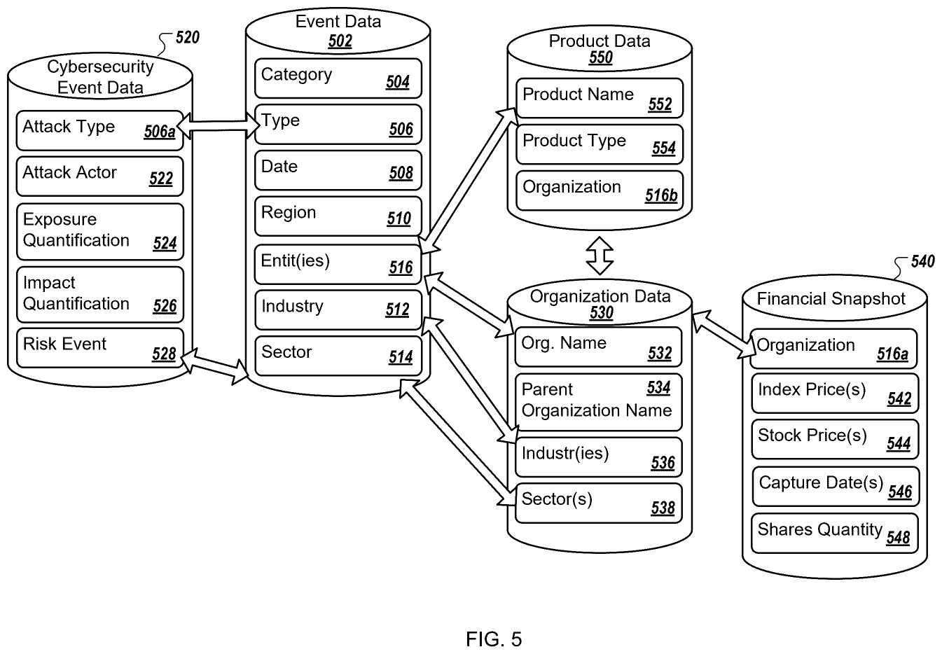

The risk event taxonomy 128, in some embodiments, includes information useful in collecting event data 502 as illustrated in FIG. 5. Turning to FIG. 5, the risk event taxonomy for a cybersecurity event data 520 may be relevant to capturing, from the source news articles 120, an attack type 506a, an attack actor 522, an exposure quantification 524, an impact quantification 526, as well as general risk event data 528 illustrated in the event data 502 (e.g., date 508, region 510, industry 512, and/or sector 514). In illustration, the event data 502 may include the event category 504 (e.g., digital disruption), the event type 506 (e.g., cyber attack), the event date(s) 508 (e.g., start date, end date, and/or date range), a region 510 (e.g., geographic location(s)), the industry 512 (e.g., health care, transportation, agriculture, finance, construction, energy, retail, etc.), and the sector 514 (e.g., communication services, consumer discretionary, information technology, industrials, etc.). Further to the illustration, the cybersecurity event data structure 520 includes the attack type 506a (e.g., data breaches, phishing attacks, ransomware attacks, malware, etc.), the attack actor 522 (e.g., internal, cybercriminal, hacktivist, governmental, etc.), the exposure quantification 524 (e.g., number of systems affected, number of accounts breached, etc.), and the impact quantification 526 (e.g., ransom payment amount, stolen funds, remedial costs, etc.). The risk event taxonomy 128 may, in some embodiments, be defined, or related to a larger risk taxonomy defining multiple event types 506 and/or event categories 504 (e.g., the categories 1000a-f of FIG. 10 and their underlying event types).

Returning to FIG. 1A, the risk event taxonomy, in some embodiments, is configured to capture risk events according to a particular risk definition (e.g., a definition of product liability risk event) using a set of indicators (terms and/or phrases) indicative of the subject matter pertaining to the subject risk event (e.g., defect, defective, product, “product design,” injury, damage, negligent, negligence, dangerous, warranty, hazardous, liability, “consumer protection,” consumer, etc.). The risk event taxonomy, further, may include measurable factors to quantify a severity or seriousness of the risk event (e.g., categories of hurricanes, Richter scale for earthquakes, etc.).

Based on the article labeling prompt 130 and in view of the risk event taxonomy 128, in some implementations, the AI network(s) 126 (e.g., large language models (LLMs)) identify, from the emerging risk publication data 122, a portion of the source news articles 120 relevant to the risk event defined by the risk event taxonomy 128. The AI network(s) 126 may further collect data related to each relevant article from the emerging risk publication data store 122 and arrange the article data in a risk labeled publication data store 132. The data store 132, for example, may be a vector data store, and the article data may be formatted into vector form and linked within the vector database according to article information and further according to the labeling. Terms in the articles may be labeled, for example, according to the set of indicators of the risk event taxonomy 128.

The risk type, in some embodiments, includes both a primary risk type (e.g., natural disaster, cyber security event, etc.) and, for at least a portion of potential risk events, a downstream (e.g., secondary) risk type. The downstream risk types may be follow-on risk that stems directly from the risk event, such as, in some examples, reputational risk and/or supply chain risk. In illustration, natural disasters may result in a supply chain disruption but will probably not result in a reputational risk unless the supply chain disruption leads to a painful downstream loss of products and/or services by customers that customers view as having been readily avoided. Conversely, in another illustrative example, loss of sensitive customer data through a cybersecurity attack will likely leave an organization vulnerable to reputational risk.

Turning to FIG. 1B, for risk events that may expose the subject organization to a secondary risk event, in some implementations, a process 150 is invoked to collect an initial financial snapshot of the organization's valuation. The engines of the process 150, in some embodiments, are configured as software routines or processes (e.g., at least a portion of a software program) coded as instructions for executing on processing circuitry, such as one or more processors. Certain engines or operations performed by certain engines, in some embodiments, are configured as hardware logic (e.g., hardware-based operations) hard-coded or programmed into processing circuitry, such as, in some examples, a programmable logic chip or other programmable logic device, an application-specific integrated circuit (ASIC), or a customized processor device.

In some implementations, an entity financial data capture engine 152 gathers information from one or more financial data sources 156 to capture an entity financial snapshot 158 for each organization registered (e.g., by the process 100 of FIG. 1A) to one of the emerging risk events relevant to secondary risk events. The entity financial data capture engine 152, for example, may access one or more market identifiers 154 from the entity structure information 110 populated by the process 100 of FIG. 1A, such as, in some examples, stock ticker information, an ISIN code, and/or financial index membership for accessing financial information from the financial data source(s) 156 as an entity financial snapshot 158. Although the financial data source(s) 156 are illustrated as being separate from the organizational structure source(s) 106 of FIG. 1A, in some embodiments, one or more content sources may reliably provide both organizational structure data and financial data (e.g., Bloomberg L.P.). In this manner, in other embodiments, aspects of the process 150 of FIG. 1B may be executed at the time of enterprise selection to automatically capture financial data (e.g., regardless of risk event type or in view of the risk event taxonomy 128).

The entity financial snapshot 158, for example, may include a current valuation for the subject organization such as, in some examples, a stock price, recent stock market performance (e.g., past week, past two weeks, etc.), and/or most recently reported valuation (e.g., balance sheets, income statements, cash flows, etc.). If applicable, in the event of a large organization spanning multiple geographies, sectors, and/or industries, the entity financial snapshot 158 may include financial data specific to a geography, industry, and/or sector affected by the emerging risk event. Conversely, if the subject entity of a particular emerging risk event is a subsidiary of a publicly traded company, the entity financial data capture engine 152 may alternatively or additionally collect financial data regarding the publicly traded company to evaluate a potential impact to the larger organization as a whole. The determination of which organization(s) to monitor financially within a corporate structure may depend on a number of factors including, in some examples, availability of up-to-date financial information corresponding to the subject entity and/or anticipated impact of financial risk to the larger organization due to the risk event suffered by the subject entity. The entity financial snapshot 158 may be stored to event entity data 160 including the entity financial snapshot 158 and the entity structure information 110. The stored data may be timestamped at time of capture to represent a financial snapshot of the subject organization.

Turning to FIG. 5, for example, the data defining each organization may be organized as organization data 530, including an entity name 532, a parent organization name 534, one or more industries 536 relevant to the named entity, and one or more sectors 538 relevant to the named entity. The organization data 530 may further be linked to one or more sets of financial snapshot data 540, each collection of financial snapshot data 540 including the organization 516a (e.g., organization name 532 or an identifier), as well as one or more index prices 542 and/or one or more stock prices 544. Each set of financial snapshot data 540 may include one or more capture dates 546, such as a stock price capture date and a valuation report capture date. In another example, the financial snapshot data 540 may include a quantity of shares 548.

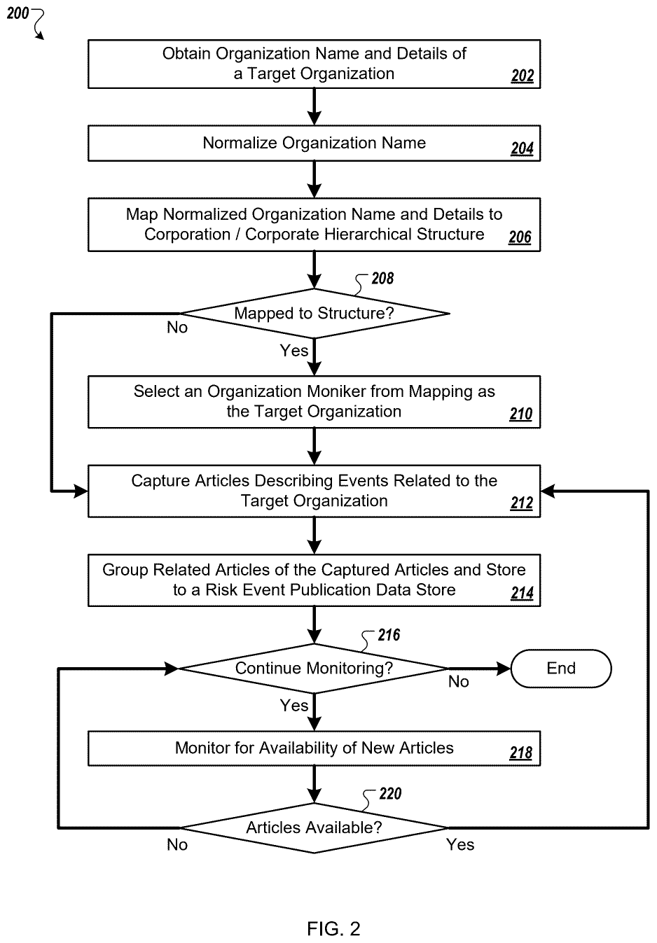

Turning to FIG. 2, a flow diagram illustrates an example method 200 for capturing and analyzing emerging risk event data. Portions of the method 200 may be performed, in some examples, by the organization normalization/mapping engine 102, the publication capture & ingesting engine 114, and/or the publication analyzing engine 124 of the process 100 of FIG. 1A.

In some implementations, the method 200 begins with obtaining an organization name and details of a target organization (202). The organization name and details, in some examples, may be provided by an end user, ingested from a set of clients stored to one or more files, and/or received via an application programming interface from an external computing system. The organization details, in some examples, may include one or more of a geographic region, at least a portion of an address, an industry, a sector, and/or a product or product line.

Turning to FIG. 5, in some embodiments, the organization data 530 of one or more organizations is linked to product data 550 for one or more products. Each product may be represented, in some examples, with a product name 552 and/or a product type 554. In other examples, the product details may include item number and/or code, product line, product release date, and/or product option level/package. In the illustration of a vehicle, for example, the product type may be sedan, the product line may be the make, the product may be the model, the release date may be the manufacturing year, and product option level/package may include a sports package, luxury package, etc.

Returning to FIG. 2, in some implementations, the organization name is normalized (204). The organization may be normalized, for example, as described in relation to the organization normalization/mapping engine 102 of FIG. 1A.

In some implementations, the normalized organization name and details are mapped to a corporation and/or a corporate hierarchical structure (206). The mapping, for example, may be performed as described in relation to the organization normalization/mapping engine 102 of FIG. 1A to determine the matching organization(s) 108.

If the organization name was mapped to a structure including two or more organizations (208), in some implementations, an organization moniker is selected from the mapping as the target organization (210). The selection, in some examples, may be based at least in part on organization type (e.g., a large employer as compared to an umbrella holding company), an organization financial state (e.g., publicly held parent versus a subsidiary lacking a tracked stock market value), and/or a closest match to the organization details (e.g., appropriate geographical area, industry, and/or sector). Selecting the organization moniker may involve importing organization details (e.g., address, industry, sector, etc.) as details for the selected target organization.

In some implementations, articles describing events related to the target organization are captured (212). The articles may be captured, for example, as described in relation to the publication capture and ingesting engine 114 of FIG. 1A. The articles may be captured, for example, as source news articles 120 from one or more publication sources 116.

In some implementations, related articles of the captured articles are grouped and the articles are stored to a risk event publication data store (214). The articles may be identified as being related, in one example, by the publication source(s). In another example, the articles may be identified as being related based on title and/or a summary (e.g., an abstract section or a summary provided by the publication source(s)). Identifying and grouping related articles is described in more detail in related application Ser. No. 19/263,119 entitled “Emerging Risk Event Detection and Evaluation” and filed Jul. 7, 2025.

In some implementations, it is determined whether to continue to monitor for articles describing events related to the target organization (216). In some examples, the determination may be based at least in part on a recency of initiating a search (e.g., the first search, a search conducted within X days of the first search), a quantity of articles captured (e.g., as a total number and/or a relative quantity in comparison to the first search), and/or user settings.

If it is determined to continue monitoring (216), the availability of new articles related to the target organization may be monitored (218). For example, a watch may be placed with one or more of the publication sources or a publication capture and organization system configured to collect articles from the publication source(s). In another example, a task may be generated to perform an additional capture at a future time.

In some implementations, if articles are available (220) (or, conversely, the task is triggered for checking for new articles), the method 200 repeats the capturing (212), the grouping (214), and the determining (216) until it is determined to cease monitoring (216).

Although described in relation to a particular set of operations, in other embodiments, the method 200 may include more or fewer operations. For example, in some embodiments, pre-determined normalized organization names and details may be accessed from a database rather than normalizing (204) and mapping (206). The normalized organization names and structures, for example, may be captured in the organization structure 530 of FIG. 5. As shown in FIG. 5, for example, the organization structure 530 may include general entity information previously stored and linked to event data corresponding, potentially, to multiple past risk events in addition to a present emerging risk event. For example, as illustrated, the event data 502 may include entity identifiers(s) 516 linking to one or more entity data structures 530, where the particular industry 512 of potentially multiple industries 536 and/or a particular sector 514 of potentially multiple sectors 538 relevant to the particular risk event corresponding to the event data 502 are identified.

Returning to FIG. 2, further, although described in relation to a particular series of operations, in other embodiments, certain operations of the method 200 may be performed in a different order and/or concurrently. For example, the storing (214) may be performed prior to the grouping (214), where grouping includes logically linking stored article data together. Other modifications of the method 200 are possible.

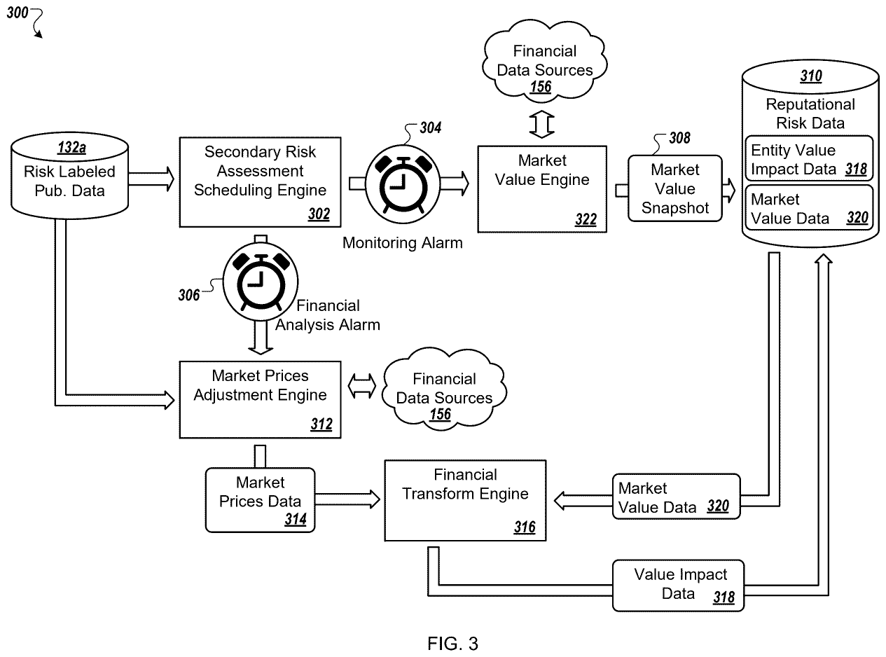

Turning to FIG. 3, a flow diagram illustrates an example process 300 for quantifying the impact of secondary risk stemming from an emerging risk event. As described in relation to FIG. 1B, upon identifying the emerging risk event, an initial snapshot of financial data 117 may be captured. Conversely, in some embodiments, the initial snapshot of financial data 117 may be captured after clustering risk events and refining understanding of the entity involved via the entity refining engine 214 of FIG. 2. To assess whether the emerging risk results in a reputational risk impact, differences in financial data from a time corresponding to the identification of the emerging risk event to one or more later time periods may be analyzed to evaluate whether financial loss has occurred beyond that which may be attributed to the primary emerging risk event. Further, the shift in financial data may be analyzed in view of more general market shifts to isolate change not attributed to other external forces. The process 300 may be performed using the clustered emerging risk events 210 of FIG. 2. The various engines of the process 300, in some embodiments, are configured as software routines or processes (e.g., at least a portion of a software program) coded as instructions for executing on processing circuitry, such as one or more processors. Certain engines or operations performed by certain engines, in some embodiments, are configured as hardware logic (e.g., hardware-based operations) hard-coded or programmed into processing circuitry, such as, in some examples, a programmable logic chip or other programmable logic device, an application-specific integrated circuit (ASIC), or a customized processor device.

In some implementations, the process 300 begins with a secondary risk assessment scheduling engine 302 scheduling one or more monitoring alarms 304 for monitoring a financial status of each organization identified in a set of risk labeled publication data 132a (e.g., a subset of the risk labeled publication data 132 relevant to downstream risk impact). The monitoring alarms 304, in some examples, may be more frequent (e.g., to gather a data corpus encompassing many emerging risk events that may be analyzed to identify trends in timing of reputational risk impact in comparison to the timing of the emerging risk event) or less frequent (e.g., to limit storage and processing resources). Further, in some embodiments, different monitoring alarms 304 may be set on a different schedule, such that certain types of data are gathered less frequently than others (e.g., stock price monitoring may be more frequent than balance sheet monitoring, since balance sheets do not undergo such frequent change). In other embodiments, rather than setting a monitoring alarm, financial data may be automatically captured at the time of entering the process 300.

In some implementations, the secondary risk assessment scheduling engine 302 schedules at least one financial analysis alarm 306 for analyzing financial data collected in relation to one or more organizations identified in the risk labeled publication data 132a (e.g., based on the monitoring alarm(s) 304) in view of initial financial data (e.g., the entity financial snapshot 158 of FIG. 1B and/or initial financial data captured by the process 300). The financial analysis alarm 306, in some embodiments, is coordinated with a final monitoring alarm of the monitoring alarm(s) 304. For example, rather than having two separate alarms, including a final monitoring alarm 304 and the financial analysis alarm 306, the financial analysis alarm 306 may trigger the same process as the monitoring alarm 304.

In some implementations, a market value engine 322 analyzes current financial data from the financial data sources 156 to determine a market value (e.g., market capitalization or “market cap,” valuation provided in annual reports, etc.) for each organization identified in the risk labeled publication data 132a. The market value engine 322, for example, may be triggered responsive to the monitoring alarm 304 and/or responsive to creation of the risk labeled publication data 132a. The market value engine 322 may produce a market value snapshot 308 (e.g., current number of shares and price per share, current market capitalization, etc.). The market value snapshot 308 may be added to a market value data set 320 as part of a reputational risk data collection 310.

Turning to FIG. 5, in some implementations, a financial snapshot data structure includes an entity identification 516a (e.g., one of the entities 516 captured in the event data 502), one or more index prices 542, one or more stock prices 544, a quantity of shares 548, and a capture date 546 corresponding to each collected price 542, 544.

Returning to FIG. 3, in some implementations, a market prices adjustment engine 312 analyzes market financial trends of at least one market relevant to each subject organization (e.g., based on industry, sector, index, stock ticker, and/or other organization obtained from the risk labeled publication data 132a) to obtain a baseline movement in the applicable market over the span of time that the event(s) corresponding to the risk labeled publication data 132a have been monitored (e.g., beginning with an initial market value snapshot 308 to the day of the financial analysis alarm 306). The market prices adjustment engine 312 may obtain financial data from the financial data sources 156 (e.g., on a periodic basis to collect and retain trend information relevant to various categories of entities that may be subject to emerging risk events, historic data captured by one or more of the financial data sources 156 covering the relevant time period, etc.). The market prices adjustment engine 312, for example, may determine one or more financial trends exhibited within one or more markets. In some examples, the stock market indices for the relevant world region (e.g., North America, Europe, Asia-Pacific, etc.), market changes within a more specific geographic region, market changes within a relevant industry, and/or market changes within a relevant sector may be analyzed by the market prices adjustment engine 312 to identify general financial trends underlying a timeframe between the start of the emerging risk event and the last entity financial snapshot 308. The market prices adjustment engine 312 may generate market prices data 314 representing movements in one or more relevant markets of the relevant time period.

In some implementations, a financial transform engine adjusts the market value data 320 of the subject organization to account for market movements evidenced in the market prices data 314 to produce value impact data 318 representing the financial impact to the entity that may be attributed to a secondary reputational risk event. The value impact data 318 may be stored as entity value impact data 318 in the reputation risk data collection 310.

Although described as occurring once, the financial analysis path of the market prices adjustment engine 312 and the financial transform engine 316 may be repeated. For example, the impact may expand as additional details are discovered regarding the emerging risk event (e.g., the number of systems breached in a cybersecurity attack, the number of user accounts that were exposed to potential data theft, etc.), such that a first review may identify an initial impact, while a subsequent review may identify a deepening impact. Between executions of the financial analysis path, additional market value snapshots 308 may be captured on a same, accelerated, or reduced schedule. The frequency of capture, for example, may be based on a number of factors, such as type of risk event, frequency of movement in the marketplace in general, and/or customization (e.g., based on user request for monitoring).

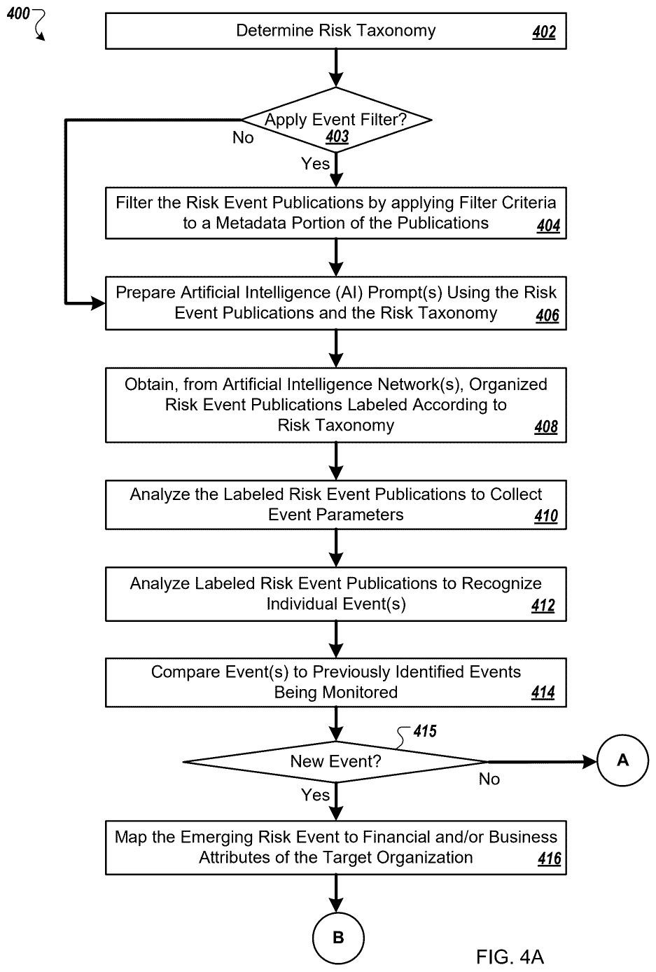

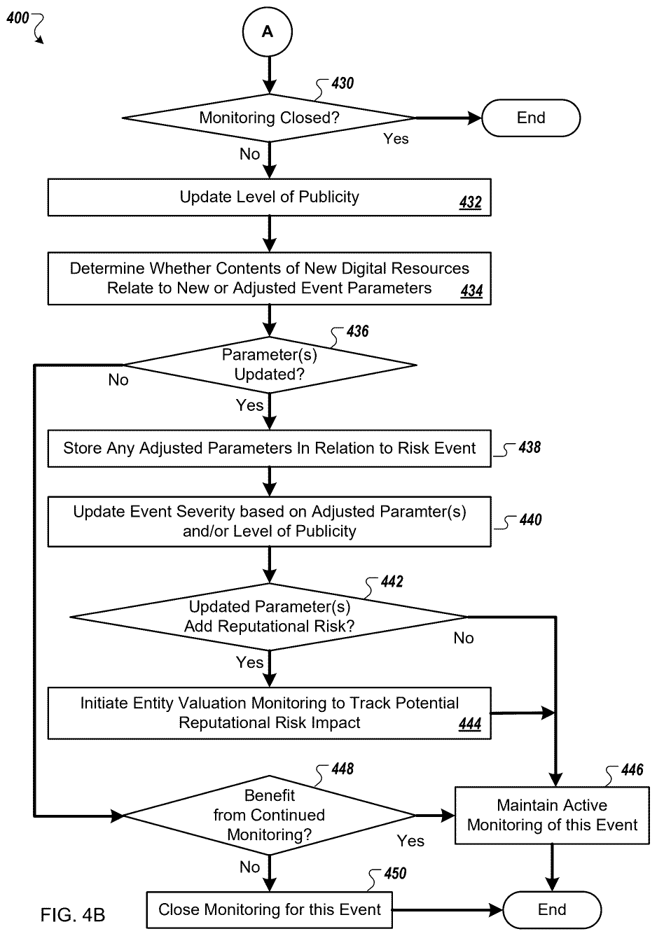

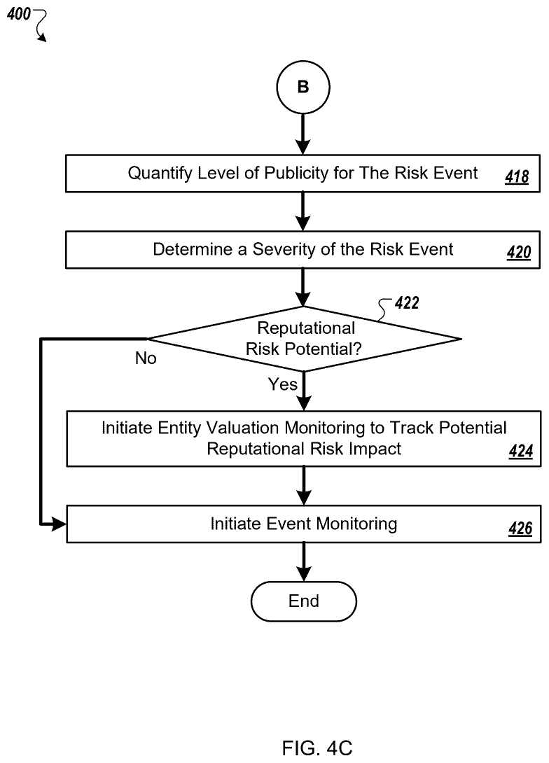

FIG. 4A through FIG. 4C illustrate a flow chart of an example method 400 for identifying and collecting information related to emerging risk events. Aspects of the method 400, may be performed, for example, by certain engines of the process 100 of FIG. 1A, the process 150 of FIG. 2B, the method 200 of FIG. 2, and/or the process 300 of FIG. 3.

Turning to FIG. 4A, in some implementations, the method 400 begins with determining a risk taxonomy (402). The risk taxonomy, for example, may be the risk event taxonomy 128 of FIG. 1A. The risk taxonomy may be determined, in some examples, based at least in part on user request parameters, customer settings, an industry type, a sector type, and/or a product type. The risk taxonomy may be a custom risk taxonomy associated with a particular organization or end user. Standardized risk taxonomies, in another example, may be applied for multiple organizations for use in generating comparison metrics regarding risk event identification.

In some implementations, if an event filter is desired (403), a metadata portion of the risk event publications are filtered by filter criteria (404). In some examples, risk event publications may be filtered by industry, sector, product type, and/or geographic region to target analysis on a particular segment of an organization. The publication analysis engine 124, for example, may filter the emerging risk publication data 122 by filter criteria.

In some implementations, whether or not the risk event publications are filtered, one or more artificial intelligence (AI) prompts are prepared using the risk event publications and the risk taxonomy (406). The AI prompt(s) may be configured, for example, to identify, within each risk event publications, entities defined within the taxonomy and tag each instance according to entity type. The AI prompt(s), further, may be configured to summarize each risk event publication according to one or more aspects of a risk event (e.g., an actor and/or cause, a date and/or timeframe, one or more locations effected by the event, an outcome (e.g., extent of damage, estimated, cost, number of individuals (e.g., customers, clients, etc.) effected, etc.).

In some implementations, organized risk event publications, labeled according to the risk taxonomy, are obtained from the artificial intelligence network(s) (408). The risk event publications, for example, may be organized within a vector database. The vector formatting, for example, may capture relationships between the named-entities recognized within each publication and unstructured natural language contents surrounding the recognized named-entities. The vector database contents may be linked, in illustration, as a knowledge graph.

In some implementations, the labeled risk event publications are analyzed to collect event parameters (410). The event parameters, in some examples, may include a location of the emerging risk event, a date or start date of the emerging risk event, an event category, an event type, an event exposure quantification, and/or an event impact quantification. For example, a portion of the event parameters may be stored in the event data structure 502 of FIG. 5. The publication analyzing engine 124 of FIG. 1A may collect the event parameters.

In some implementations, the labeled risk event publications are analyzed to recognize individual events (412). The entity types of the emergency risk taxonomy, in some embodiments, include emerging risk event information (e.g., the “who,” “what,” “when,” “why,” “where,” and “how,” such as the location of event, the timing of event, who the event effects, what occurred in the event, how the event took place, etc.). The AI network(s), for example, may be trained or fine-tuned to parse the “5W1H” facts out of news articles based on contextual cues within the text. The where, for example, can include areas defined by political boundaries, a governing body applicable to a geographic area, and/or another representation of geographic region. Thus, the start date, location, actor, and/or cause of each risk event, in some examples, may be compared to determine whether all publications relate to a single risk event corresponding to the risk taxonomy (e.g., risk type) or if multiple events have been described within the captured publications. If two or more risk events of the same risk type are identified, the risk publications may be clustered or otherwise segregated according to risk event.

In some implementations, the event(s) are compared to previously identified events being monitored (414). As events unfold, additional details may be released via one or more content sources (e.g., the publication source(s) 116 of FIG. 1). Risk event data (e.g., the event data 502 of FIG. 5) may be compared to information derived from the newly analyzed resources to determine whether the digital resources correspond to a previously identified emerging risk event.

In some implementations, if the recently analyzed resources correspond to a newly identified risk event (415), the emerging risk event may be mapped to financial and/or business attributes of the dominant organization (416). For example, as illustrated in FIG. 5, the event data 502 of the emerging risk event may be mapped to the industry 512 and/or the sector 514 of the entity data 530 for the dominant organization.

Turning to FIG. 4C, in some implementations, a level of publicity for the emerging risk event is quantified (418). The publicity level, for example, may equate to a level of press associated with the risk event (e.g., a number of digital resources, a geographic reporting distribution of the digital resources, etc.). The publicity level may further be based on a typical level, or a set of publicity tiers, determined from past emerging risk events of the same type. The publicity level may further be adjusted, in some embodiments, based on a reputation of the organization (e.g., whether the organization or its product(s) is a household name) and/or other factors regarding the risk event, such as the geographic region, industry, and/or sector. For example, greater media emphasis may be placed on events occurring in major financial markets (e.g., North America, Europe, China, etc.), and/or within sectors or industries of great interest to the general public.

In some implementations, a severity level of the risk event is determined (420). In some circumstances, the severity level may be derived from the digital resources, such as a hurricane's severity level. In other circumstances, the severity level may be determined based in part on the publicity level. The severity, further, may relate to the exposure quantification and/or the impact quantification (described, for example, in relation to FIG. 5).

In some implementations, it is determined whether the emerging risk event creates the potential for a reputational risk event (422). The publication analyzing engine 124 of FIG. 1, for example, may determine one or more types of potential secondary risk, including reputational risk.

If the risk event creates the potential for a reputational risk event (418), in some implementations, entity valuation monitoring is initiated to track potential reputational risk impact (424). The entity valuation monitoring, for example, may be performed as described in relation to the process 300 of FIG. 3.

In some implementations, event monitoring is initiated (426). After initial identification of the emerging risk event, further details and additional information may be released through online content sources over the course of additional days or even weeks. With event monitoring, in some embodiments, later digital resource postings may be analyzed and their contents added to contribute to information such as the exposure quantification and/or the impact quantification. As described in relation to operation 414, for example, the event may not be new (e.g., it may be in a monitoring stage for further information).

Returning to FIG. 4A, in some implementations where the given risk event is not a new event (408), as illustrated in FIG. 4B, it is determined whether monitoring is closed for the risk event (430). As noted in FIG. 4C, event monitoring may be initiated (426) to continue to track coverage of an emerging risk event. If monitoring remains ongoing (430), in some implementations, a level of publicity associated with the emerging risk event is updated (432). The level of publicity, for example, may be calculated in the manner described in relation to operation 418 of FIG. 4C.

In some implementations, it is determined whether the contents of the new digital resources relate to new or adjusted event parameters (434). For example, the new digital resources may be analyzed as described in relation to operation 410 of FIG. 4A, and compared to the originally stored event parameters.

If the new digital resources include updated parameters (436), in some implementations, any adjusted parameters are stored in relation to the emerging risk event (438). The parameters may be stored, for example, in the event data 502 and/or other event data linked to the event data 502 (e.g., the cybersecurity event data 520), as described in relation to FIG. 5.

In some implementations, the event severity is updated based on one or more of the adjusted parameters and/or the level of publicity (440). The event severity, for example, may be determined in the manner described in relation to operation 420 of FIG. 4C.

In some implementations, if the updated parameter(s) add a new aspect of reputational risk (442), entity valuation monitoring is initiated to track potential reputational risk impact (444). For example, the original, limited details regarding the emerging risk event may not have captured details relevant to the potential for a secondary reputational risk-related loss occurring. In this circumstance, as details unfold that point to the potential for reputational risk, valuation monitoring may be initiated as described in relation to operation 424 of FIG. 4C.

When one or more parameters have been updated, in some implementations, active monitoring of the event is maintained (446). For example, since new details are still being released to the public, the emerging risk event can be considered to remain active.

In some implementations where no parameters have been updated (436), it is determined whether there may be a benefit derived through continued monitoring (448). As publicity wanes and no new information is automatically gleaned through analysis of new digital resources, the emerging risk event may be deemed as not requiring additional monitoring. In this manner, if a similar event strikes the same organization a second time (e.g., a series of wildfires, etc.), the second event will be recognized as a separate emerging risk event. In addition to and/or instead of waning publicity, the monitoring may be closed upon the end of secondary risk monitoring. In some embodiments, where it is determined that continued monitoring is not beneficial (448), monitoring for the emerging risk event is closed (450). Upon closing, for example, the event data may be archived and made available for historic trend analysis. In some embodiments, upon determining that additional benefit may be derived through continued monitoring (448), active monitoring is maintained for the emerging risk event (446).

Although described as a particular set of operations, in other embodiments, the method 400 may include more or fewer operations. For example, in certain embodiments, no reputational risk analysis may be performed. Although described as a series of operations, in other embodiments, certain operations may be performed in a different order and/or a portion of the operations of the method 400 may be performed at least partially concurrently. For example, the event parameter(s) 410 may be collected concurrently with labeling (408) the risk event publications. Other modifications to the method 400 are possible.

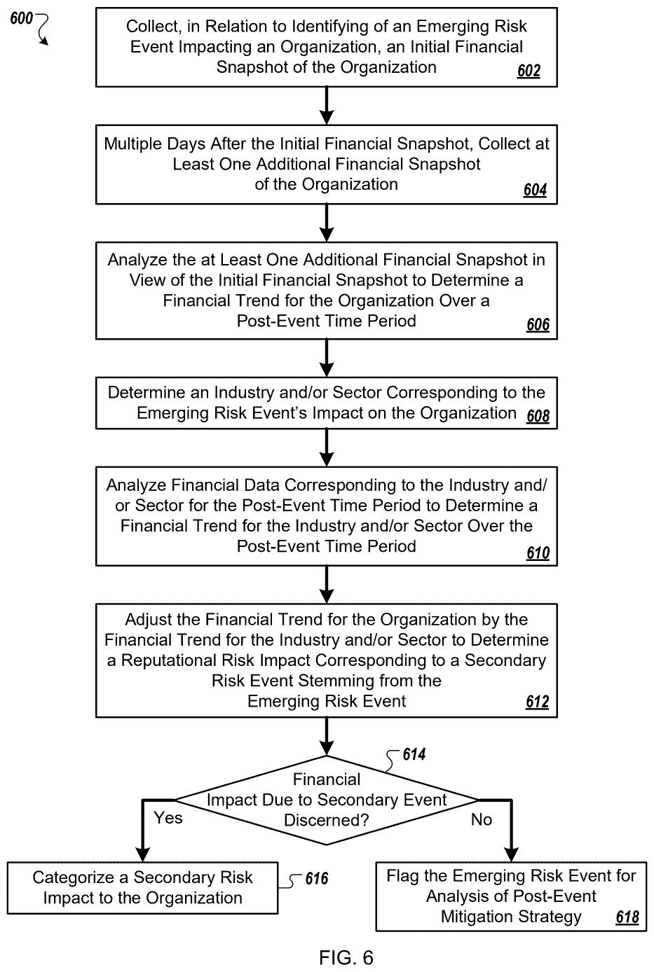

Turning to FIG. 6, a flow chart presents an example method 600 for performing historic trend analyses on reputational risk event data. Portions of the method 600, for example, may be performed by various engines of the process 300 of FIG. 3.

In some implementations, the method 600 begins with collecting, in relation to identifying an emerging risk event impacting an organization, an initial financial snapshot of the organization (602). The initial financial snapshot, for example, may be the market value snapshot 308 collected by the market value engine 322 of FIG. 3.

In some implementations, at least one additional financial snapshot of the organization is collected multiple days after the initial financial snapshot was gathered (604). The number of days, in some examples, may include at least 14 days, up to 30 days, from 30 days to 90 days, from 90 days to about four months, from about four months to about six months, from about six months to about nine months, or from about six months to about a year. The financial ramifications of a reputational impact may demonstrate significant lag. In some illustrative examples, market response to an emerging risk event may be delayed due to the delay in shareholder information distribution, the delay in running out of present stock (e.g., in a supply chain issue), and/or the delay in response implementation. Regarding response implementation, a minor financial impact (e.g., shareholder loss of confidence) may be corrected through a course of action taken by the organization. Thus, to evaluate for significant and longstanding financial impact, the reputational risk financial impact evaluation may be performed after a number of months have passed. The specific length of time may be based, for example, on historic analysis of financial impact due to reputational risk. The market value engine 322 of FIG. 3, for example, may collect the at least one additional financial snapshot.

In some implementations, the at least one additional financial snapshot is analyzed in view of the initial financial snapshot to determine a financial trend for the organization over a post emerging risk event time period (606). For example, the market value data 320 may be analyzed by the financial transform engine 316 of FIG. 3 to determine the financial trend of the market value of the subject organization.

In some implementations, an industry and/or sector corresponding to the emerging risk event's impact on the subject organization is determined (608). The industry and/or sector, for example, may be determined from data stored to the event entity data 122 (e.g., by the entity refining engine 214 of FIG. 2 and/or the organization registration/validation engine 110 of FIG. 1B).

In some implementations, financial data corresponding to the industry and/or sector is analyzed for the post-event time period to determine a financial trend for the industry and/or sector over the post-event time period (610). The financial data, for example, may include stock index values from the beginning date of the emerging risk event (or capture of first financial data for the subject organization) to a current date. Rather than using a commercial index, in some embodiments, a collection of data corresponding to key competitors in the industry and/or sector may be combined to obtain the financial data corresponding to the industry and/or sector. The market prices adjustment engine 312 of FIG. 3, for example, may analyze the financial data corresponding to the industry and/or sector.

In some implementations, the financial trend for the organization is adjusted by the financial trend for the industry and/or sector to determine a reputational risk impact corresponding to a secondary risk event stemming from the emerging risk event (612). For example, it may be assumed that the subject organization's financial trajectory would generally follow the trend for its market and/or sector. Thus, if, during the relevant time period the industry and/or sector as a whole was impacted by a separate market force outside of the emerging risk event, the separate market force may be nullified by quantifying it and removing it from the financial trend of the organization itself during the relevant time period. The financial transform engine 316 of FIG. 3, for example, may adjust the market value trend of the organization evidenced in the market value data 320 in view of the financial trend of the market prices data 314 as calculated by the market prices adjustment engine 312 to identify the value impact data 318 representing any shift in value of the organization that cannot be attributed to general market trends. The value impact data 318, thus, may be assumed to be related to the reputational risk.

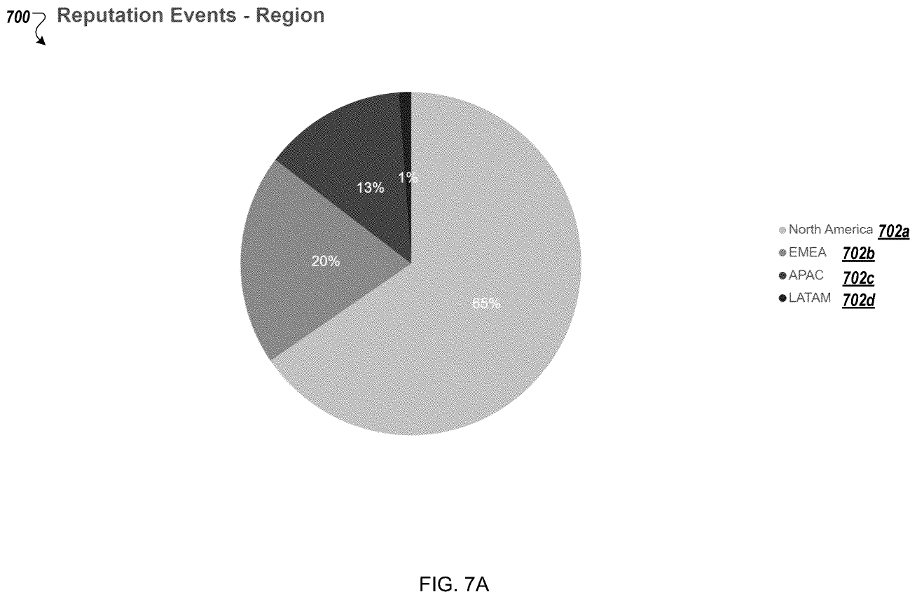

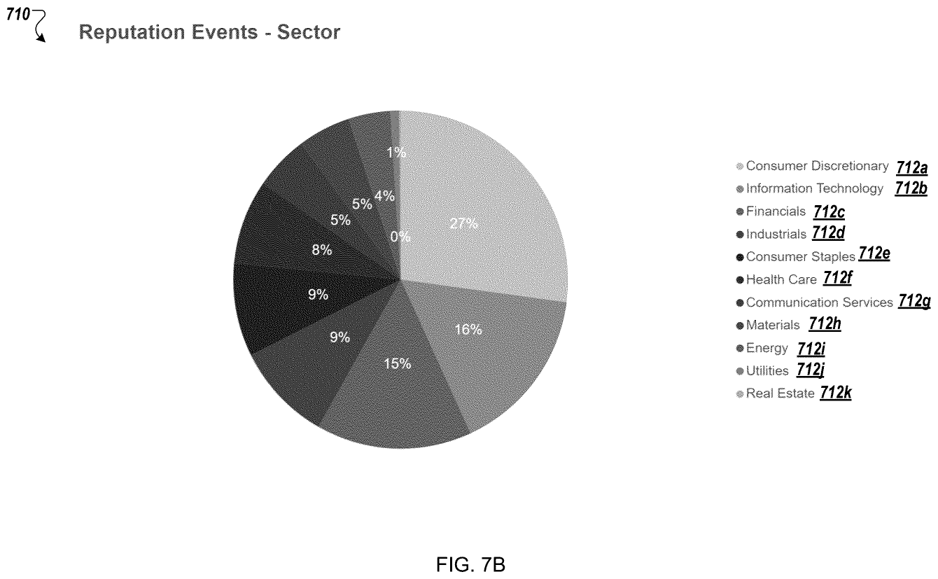

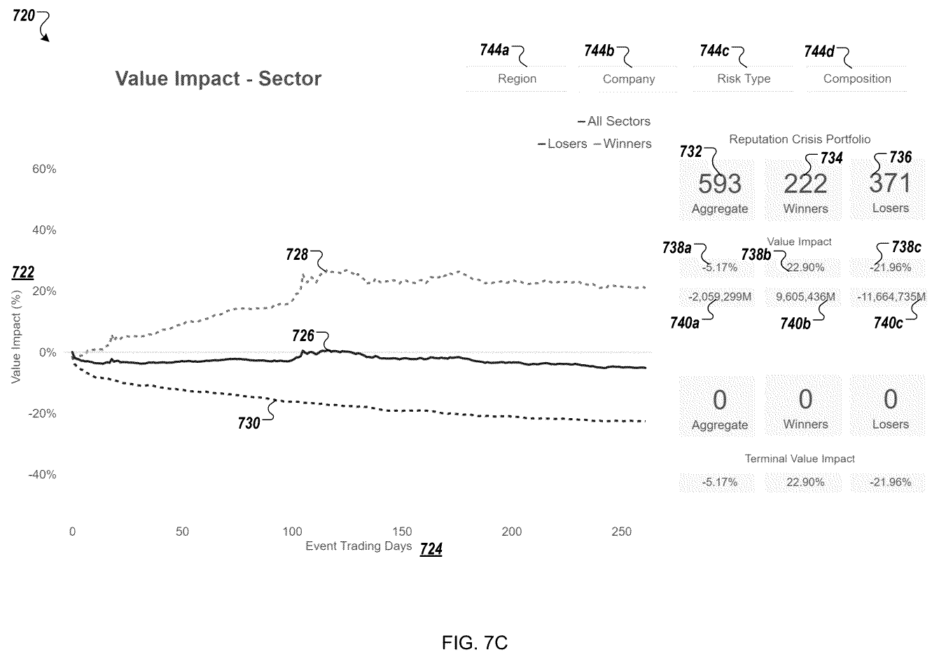

Turning to FIG. 7C, an example graphical user interface 720 illustrates a percentage value impact 722 to organizations over the course of a little over 250 days 724. The value impact data 318 of aggregate organizations 732 (e.g., 593), for example, may have been evaluated to produce the example graphical user interface 720, in which the organizations have been divided into a set of winners 734 (e.g., 222) and a set of losers 736 (e.g., 371). As illustrated in the graph of value impact 722 over event days 724, an “all sectors” plot 726 tracks a relative change in value (e.g., from day 0 at 0%) of the aggregate organizations 732 as a whole. A winners plot 728 tracks a relative change in value of the winners 734 (e.g., those organizations that increased in value from day 0 to the end of the event trading days 724), and a losers plot 730 tracks a relative change in value of the losers 736 over the event trading days 724. A value impact at the end of the trading days 724 demonstrates that the aggregate organizations lost 5.17% value 738a, the winners increased in value by 22.9% 738b, and the losers decreased in value by 21.96% 738c. The change in value has also been captured in millions of dollars 740a-c.

To refine the analysis presented in the example graphical user interface 720, a user may filter the data presented by region 744a, by company (e.g., organization) 744b, by risk type 744c (e.g., primary emerging risk type), and/or by composition 744d. In composition mode, for example, the composite components may be broken out by category (e.g., by region, by sector, by industry, etc.). For example, the example graph 700 of FIG. 7A and the example graph 710 of FIG. 7B illustrate composition breakdowns by region and by sector, respectively.

Returning to FIG. 6, in some implementations, if a secondary financial impact is discerned (614), a secondary risk impact to the organization is categorized (616). In some circumstances, it may be determined that, based on the calculations in view of the industry and/or sector, the organization's financial trajectory has been on par with its peers. In determining whether there has been a discernable secondary financial impact, in some embodiments, the method 600 calculates whether an anticipated financial value of the organization differs from an actual financial value of the organization by at least a threshold amount and/or a threshold percentage. The threshold value(s), in some embodiments, are based at least in part on a distribution of outcomes among peer organizations within the industry and/or sector.

In some implementations where there has been a discernable financial impact attributable to a secondary risk event (e.g., reputational and/or supply chain), a secondary risk impact to the organization is categorized (616). In the simplest form, a secondary risk event may be logged in relation to this organization (e.g., a binary yes, the organization was impacted by a secondary risk event). For example, as illustrated in an example graphical user interface 700 of FIG. 7A, a pie chart of reputational events by region (e.g., by calendar year, by quarter, etc.) is illustrated. In this circumstance, the geographic region of the event (e.g., the geographic region of the organization or the geographic region of the emerging risk event) is analyzed to quantify a share of reputational risk events per each of North America 702a (e.g., 65%), Europe, Middle East, and Africa (EMEA) 702b (e.g., 20%), Asia-Pacific (APAC) 702c (e.g., 13%), and Latin America (LATAM) 702d (e.g., 1%). In another example, turning to FIG. 7B, an example graphical user interface 710 illustrates a pie chart of reputational events by sector. In this circumstance, the sector of the organization impacted by the emerging risk event is analyzed to quantify a share of reputational risk events per each of consumer discretionary 712a (e.g., 27%), information technology 712b (e.g., 16%), financials 712c (e.g., 15%), industrials 712d (e.g., 9%), consumer staples 712e (e.g., 9%), health care 712f (e.g., 8%), communication services 712g (e.g., 5%), materials 712h (e.g., 5%), energy 712i (e.g., 4%), utilities 712j (e.g., 1%), and real estate 712k (e.g., 0%). In other embodiments, a relative severity of the secondary risk event may be quantified. For example, based on a relative difference between the anticipated financial trajectory of the organization and the actual financial trajectory of the organization, the secondary risk event may be quantified as minor, serious, or severe. Perhaps, if the organization has a major financial event such as bankruptcy, the secondary risk event may be quantified as catastrophic. Other categorizations are possible.

In the example of a supply chain risk, in some embodiments, diagnostic metrics may compare supply chain risk mitigation effectiveness against multiple critical supplier and/or enterprise exposures.

In some implementations, where a financial impact attributable to a secondary risk event is not discerned (614), the emerging risk event is flagged for analysis of the post-event mitigation strategy adopted by the organization. For example, the post-event mitigation strategy may be analyzed by other organizations impacted by a similar primary emerging risk event to develop a mitigation plan with at least some proven track record for being successful in staving off the further impact of a reputational risk event.

Although described in relation to the industry and/or sector (608), in other embodiments, the stock index, relevant stock ticker, geographical region of the corporate headquarters, and/or the geographic region of the emerging risk event may be determined and used to calculate financial trends in an appropriate comparison market. In other embodiments, certain operations of the method 600 may be performed in a different order and/or concurrently. For example, the financial data corresponding to the industry and/or sector may be analyzed (610) prior to or concurrently with analyzing the additional snapshot(s) in view of the initial financial snapshot (606). In further embodiments, the method 600 may include more or fewer operations. Other modifications of the method 600 are possible.

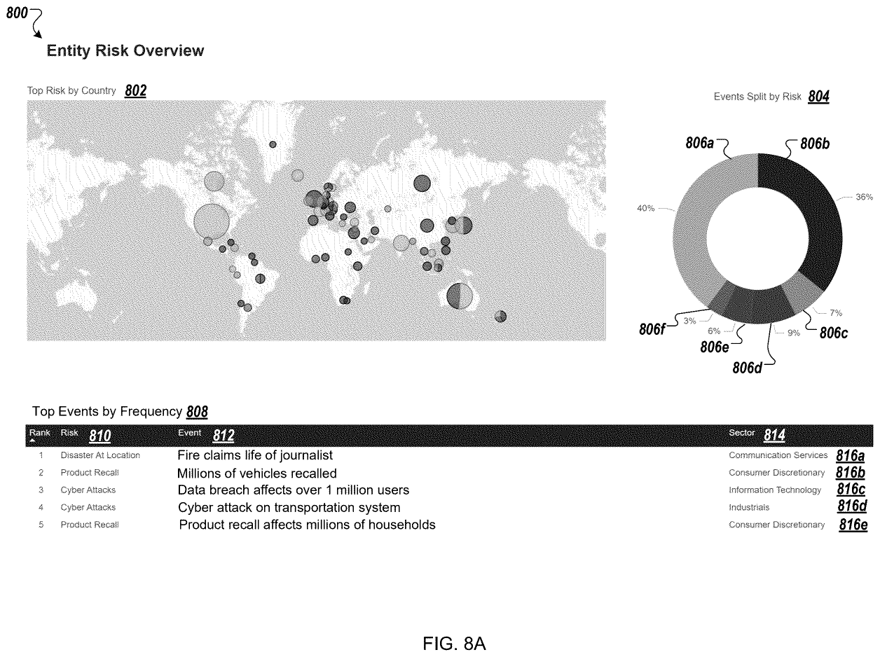

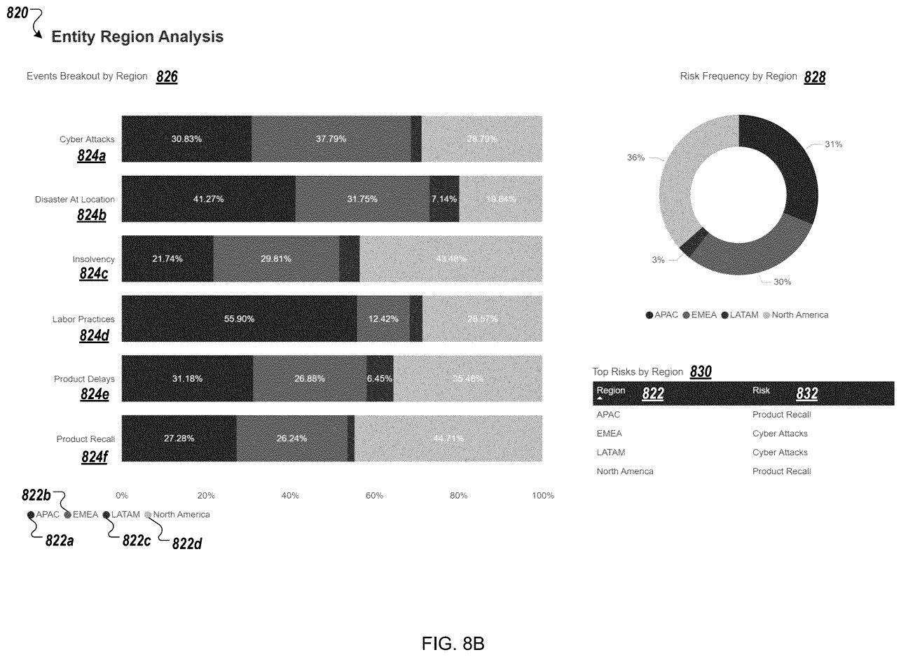

FIG. 8A and FIG. 8B illustrate example graphical user interfaces presenting regional analyses of emerging risk events by event type. The graphical user interfaces, for example, may be developed using the data and metrics generated through the process 100 of FIG. 1A, the process 150 of FIG. 1B, the method 200 of FIG. 2, the process 300 of FIG. 3, the method 400 of FIG. 4A through FIG. 4C, and/or the method 600 of FIG. 6.

Turning to FIG. 8A, an example graphical user interface (GUI) 800 illustrates a risk overview based on types of emerging risk and frequency of each within various geographic regions (e.g., countries). The data, for example, may represent a period of time such as a business year, a calendar year, or a business quarter. The GUI 800 may be reviewed by an entity to determine preferred regions of operation and/or to distribute risk better across a supply chain based on frequency of different types of risk in each region. For example, when deciding where to place a new data center, the propensity for cyber attacks may be reviewed in the various countries.

As illustrated, the GUI 800 includes a graph of top risks by country, each country overlaid with a color-coded risk bubble. Further, the risk bubbles may be sized to represent overall propensity within the region as compared to other countries (e.g., the bubble over the United States is larger than the bubble over Canada). The color-coded risks, for example, may include cyber attacks, disaster at location, insolvency, labor practices, product delays, and/or product recall (e.g., as broken out in a graphical user interface 820 of FIG. 8B).

A donut graph of events split by risk 804 breaks down the various risk categories 806 by the portion of total emerging risks detected (e.g., cyber attacks, disaster at location, insolvency, labor practices, product delays, and product recall).

A top events by frequency listing 808 may list the top events of the subject time period by frequency of mention in the press (e.g., number of articles detected by the process 100 of FIG. 1A later determined by the event data clustering engine 202 to belong to a single event). Each event 186a-e of the top events by frequency 808 is listed along with its corresponding risk category 810, a brief summary of the event (e.g., the representative title discussed in relation to the event data clustering engine 202), and the corresponding sector 814.

In other embodiments, an event trend graph (not illustrated) may be presented to illustrate a number of events (e.g., cyber attack events, etc.) per time period (e.g., month, quarter, etc.) over a span of time (e.g., six months, one or more years, etc.). The event trend graph, in some examples, may demonstrate whether a type of event is becoming more or less frequent and/or certain quarters that are more active for the time of event.

In further embodiments, an event by company graphic may illustrate a number of companies effected by each of a category of number of event instances (e.g., none, only one, two, up to three, three or more, etc.) within a topic timeframe (e.g., one year, two years, up to five years, etc.). The event by company graphic, for example, may demonstrate that a majority of companies suffered only a single cyber attack incident within the subject timeframe, while approximately a same number or percentage of companies suffered two cyber attack events within the topic timeframe as suffered three or more cyber attacks within the topic timeframe.

Turning to FIG. 8B, an entity region analysis graphical user interface 820 presents a breakdown of risk by geographic region 822 (e.g., APAC 822a, EMEA 822b, LATAM 822c, and North America 822d). The information is broken out further by type of event 824. An organization may review the GUI 820, for example, when determining solutions for supply chain providers.

In an events breakdown by region bar graph section 826, a user can quickly identify which region is most frequently visited by each different type of attack. For example, APAC 822a has the largest percentage of disasters at location 824b and labor practice problems 824d, while North America has the greatest percentage of insolvencies 824c and product recalls 824f.

A risk frequency by region donut graph 828 illustrates overall frequency of emerging risk events, as a percentage of total risk events, for each of the regions 822. As illustrated, emerging risk events are generally most common in North America 822d and least common in LATAM 822c.

A top risk by region listing 830 lists the most common risk 832 for each region 822. As illustrated, although product recalls 824f are most common in North America 822d, APAC's top risk is product recall. Further, although North America 822d has more insolvencies 824c than any other region, North America's most common risk is product recall.

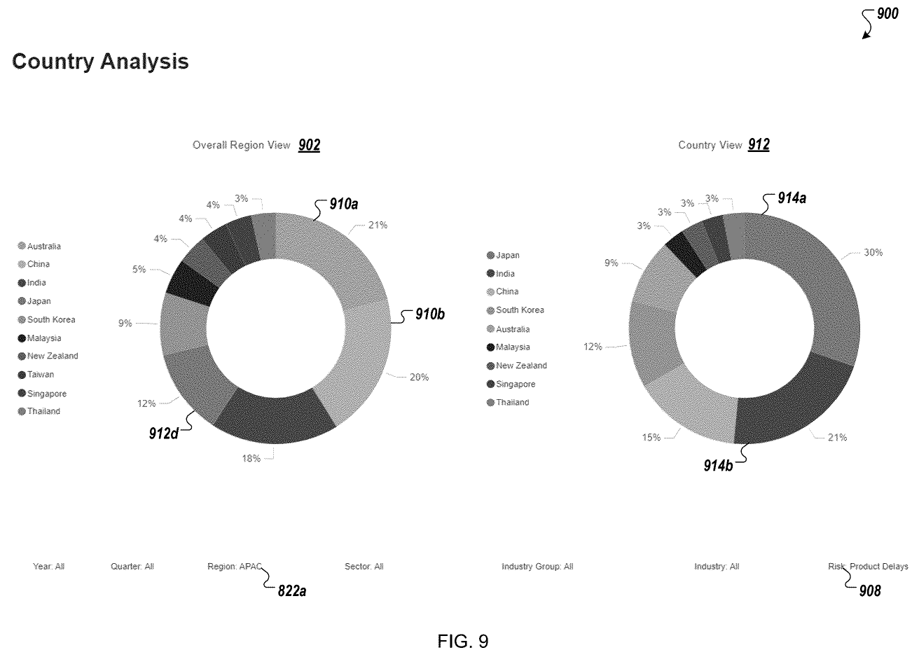

FIG. 9 illustrates an example graphical user interface 900 presenting regional analysis of risk events. The GUI 900, for example, may demonstrate how risks impact various countries and various regions.

In a region donut graph 902, the APAC region 822a is broken down by representative country, with each country represented as percentage of total impact of all types of risk. As illustrated, the country that experienced the greatest emerging event risk in APAC 822a was Australia 910a, followed by China 910b

Turning to a country view donut graph 912, the countries of the APAC region 822a are represented in relation to a selected risk, in this circumstance product delays 908. As illustrated, Japan 914a experienced the greatest impact of product delay risk, followed by India 914b.

In reviewing the GUI 900, a representative of an organization is presented differentiators between the “riskiest” countries in the APAC region 822a versus the countries experiencing the highest level of risk in an area that is of particular interest to the organization. For example, while Japan 912 d is ranked fourth in overall risk at only 12% of the emerging risk impact across the APAC region 822a, it experiences nearly a third of the entire APAC product delay risk impact.

Reviewing large sets of publications regarding emerging risk events can be resource intensive, expensive, and time consuming. Rather than reviewing all documentation collected regarding an emerging risk event, in some implementations, the documentation can be classified using intelligent screening. The screening, for example, provides a technical solution to the problem of proliferation of redundant literature, such as news articles covering the same story and including generally the same facts and descriptions. The screening resolves the issue by reducing the quantity of documents to a small number of example publications containing both a rich set of data and a diverse coverage regarding the emerging risk event. For example, the screening may identify articles that provide the most information gain along with a broad range of article style/composition.

Reference has been made to illustrations representing methods and systems according to implementations of this disclosure. Aspects thereof may be implemented by computer program instructions. These computer program instructions may be provided to a processor of a general-purpose computer, special purpose computer, or other programmable data processing apparatus and/or distributed processing systems having processing circuitry, such that the instructions, which execute via the processor of the computer or other programmable data processing apparatus, create means for implementing the functions/operations specified in the illustrations.

One or more processors can be utilized to implement various functions and/or algorithms described herein. Additionally, any functions and/or algorithms described herein can be performed upon one or more virtual processors. The virtual processors, for example, may be part of one or more physical computing systems such as a computer farm or a cloud drive.

Aspects of the present disclosure may be implemented by software logic, including machine readable instructions or commands for execution via processing circuitry. The software logic may also be referred to, in some examples, as machine readable code, software code, or programming instructions. The software logic, in certain embodiments, may be coded in runtime-executable commands and/or compiled as a machine-executable program or file. The software logic may be programmed in and/or compiled into a variety of coding languages or formats.

Aspects of the present disclosure may be implemented by hardware logic (where hardware logic naturally also includes any necessary signal wiring, memory elements and such), with such hardware logic able to operate without active software involvement beyond initial system configuration and any subsequent system reconfigurations (e.g., for different object schema dimensions). The hardware logic may be synthesized on a reprogrammable computing chip such as a field programmable gate array (FPGA) or other reconfigurable logic device. In addition, the hardware logic may be hard coded onto a custom microchip, such as an application-specific integrated circuit (ASIC). In other embodiments, software, stored as instructions to a non-transitory computer-readable medium such as a memory device, on-chip integrated memory unit, or other non-transitory computer-readable storage, may be used to perform at least portions of the herein described functionality.

Various aspects of the embodiments disclosed herein are performed on one or more computing devices, such as a laptop computer, tablet computer, mobile phone or other handheld computing device, or one or more servers. Such computing devices include processing circuitry embodied in one or more processors or logic chips, such as a central processing unit (CPU), graphics processing unit (GPU), field programmable gate array (FPGA), application-specific integrated circuit (ASIC), or programmable logic device (PLD). Further, the processing circuitry may be implemented as multiple processors cooperatively working in concert (e.g., in parallel) to perform the instructions of the inventive processes described above.

The process data and instructions used to perform various methods and algorithms derived herein may be stored in non-transitory (i.e., non-volatile) computer-readable medium or memory. The claimed advancements are not limited by the form of the computer-readable media on which the instructions of the inventive processes are stored. For example, the instructions may be stored on CDs, DVDs, in FLASH memory, RAM, ROM, PROM, EPROM, EEPROM, hard disk or any other information processing device with which the computing device communicates, such as a server or computer. The processing circuitry and stored instructions may enable the computing device to perform, in some examples, the process 100 of FIG. 1A, the process 150 of FIG. 1B, the method 200 of FIG. 2, the process 300 of FIG. 3, the method 400 of FIG. 4A through FIG. 4C, and/or the method 600 of FIG. 6.

These computer program instructions can direct a computing device or other programmable data processing apparatus to function in a particular manner, such that the instructions stored in the computer-readable medium produce an article of manufacture including instruction means which implement the function/operation specified in the illustrated process flows.

Embodiments of the present description rely on network communications. As can be appreciated, the network can be a public network, such as the Internet, or a private network such as a local area network (LAN) or wide area network (WAN) network, or any combination thereof and can also include PSTN or ISDN sub-networks. The network can also be wired, such as an Ethernet network, and/or can be wireless such as a cellular network including EDGE, 3G, 4G, and 5G wireless cellular systems. The wireless network can also include Wi-Fi®, Bluetooth®, Zigbee®, or another wireless form of communication. The network, for example, may support communications between the organization normalization mapping engine 102 of FIG. 1A and the organizational structure source(s) 106 and/or the entity structure information 110, between the publication capture & ingesting engine 114 of FIG. 1A and the publication source(s) 116 and/or the emerging risk publication data store 122, between the publication analyzing engine 124 of FIG. 1A and the AI network(s) 126, between the AI network(s) 126 and the emerging risk publication data store 122 and/or the risk labeled publication data store 132, between the entity financial data capture engine 152 of FIG. 1B and at least one of the financial data source(s) 156, the entity structure information data store 110, and/or the event entity data store 160, between the market value engine 322 of FIG. 3 and the financial data source(s) 156, and/or between the market prices adjustment engine 312 of FIG. 3 and the financial data sources 156.

The computing device, in some embodiments, further includes a display controller for interfacing with a display, such as a built-in display or LCD monitor. A general purpose I/O interface of the computing device may interface with a keyboard, a hand-manipulated movement tracked I/O device (e.g., mouse, virtual reality glove, trackball, joystick, etc.), and/or touch screen panel or touch pad on or separate from the display. The display controller and display may enable presentation of the screen shots illustrated, in some examples, in FIG. 7A through FIG. 7C, FIG. 8A, FIG. 8B, and/or FIG. 9.

Moreover, the present disclosure is not limited to the specific circuit elements described herein, nor is the present disclosure limited to the specific sizing and classification of these elements. For example, the skilled artisan will appreciate that the circuitry described herein may be adapted based on changes in battery sizing and chemistry or based on the requirements of the intended back-up load to be powered.

The functions and features described herein may also be executed by various distributed components of a system. For example, one or more processors may execute these system functions, where the processors are distributed across multiple components communicating in a network. The distributed components may include one or more client and server machines, which may share processing, in addition to various human interface and communication devices (e.g., display monitors, smart phones, tablets, personal digital assistants (PDAs)). The network may be a private network, such as a LAN or WAN, or may be a public network, such as the Internet. Input to the system, in some examples, may be received via direct user input and/or received remotely either in real-time or as a batch process.

Although provided for context, in other implementations, methods and logic flows described herein may be performed on modules or hardware not identical to those described. Accordingly, other implementations are within the scope that may be claimed.

In some implementations, a cloud computing environment, such as Google Cloud Platform™ or Amazon™ Web Services (AWS™), may be used perform at least portions of methods or algorithms detailed above. The processes associated with the methods described herein can be executed on a computation processor of a data center. The data center, for example, can also include an application processor that can be used as the interface with the systems described herein to receive data and output corresponding information. The cloud computing environment may also include one or more databases or other data storage, such as cloud storage and a query database. In some implementations, the cloud storage database, such as the Google™ Cloud Storage or Amazon™ Elastic File System (EFS™), may store processed and unprocessed data supplied by systems described herein. For example, the entity structure information 110, the emerging risk publication data 122 and/or the risk labeled publication data 132 of FIG. 1A, the event entity data 160 of FIG. 1B, the reputational risk data 310 of FIG. 3, and/or the cybersecurity event data 520, the event data 502, the organization data 530, the product data 550, and/or the financial snapshot data 540 of FIG. 5.

The systems described herein may communicate with the cloud computing environment through a secure gateway. In some implementations, the secure gateway includes a database querying interface, such as the Google BigQuery™ platform or Amazon RDS™. The data querying interface, for example, may support access by the organization normalization/mapping engine 102 of FIG. 1A to the organizational structure source(s) 106, access by the publication capture & ingestion engine 114 of FIG. 1A to the publication sources 116, access by the entity financial data capture engine 152 of FIG. 1B to the financial data source(s) 156, and/or access by the market value engine 322 and/or the market prices adjustment engine 312 of FIG. 3 to the financial data source(s) 156.

In some implementations, an edge server is used to transfer data between one or more computing devices and a cloud computing environment according to various embodiments described herein. The edge server, for example, may be a computing device configured to execute processor intensive operations that are sometimes involved when executing machine learning processes, such as the publication ingesting processes performed by the publication capture & ingesting engine 114 of FIG. 1A and/or the publication analysis operations performed by the publication analyzing engine 124 of FIG. 1A. An edge server may include, for example, one or more GPUs that are capable of efficiently executing matrix operations as well as substantial cache or other high-speed memory to service the GPUs. An edge server may be a standalone physical device. An edge server may be incorporated into other computing equipment, such as a laptop computer, tablet computer, medical device, or other specialized computing device. Alternatively or additionally, an edge server may be located within a carrying case for such computing equipment. An edge server, in a further example, may be incorporated into the communications and processing capabilities of a mobile unit such as a vehicle or drone, or may otherwise be located within the mobile unit.

In some implementations, the edge server communicates with one or more local devices to the edge server. The edge server, for example, can be used to move a portion of the computing capability traditionally shifted to a cloud computing environment into the local environment so that any computation intensive data processing and/or analytics required by the one or more local devices can run accurately and efficiently. In some embodiments, the edge server is used to support the one or more local devices in the absence of a connection with a remote computing environment. The edge server may be configured to communicate with the one or more local devices directly or via a network. For instance, the edge server can include a private wireless network interface, a public wireless network interface, and/or a wired interface through which the edge server can communicate with the one or more local devices. In some embodiments, certain local devices may be configured to communicate indirectly with the edge server, for example via another local device. Further, the edge server may be configured to communicate with a remote computing (e.g., cloud) environment via one or more public or private wireless network interfaces.

In some implementations, the organization normalization/mapping engine 102, the publication capture & ingesting engine 114, and/or the publication analyzing engine 124 of FIG. 1A, the entity financial data capture engine 152 of FIG. 1B, and/or the secondary risk assessment scheduling engine 302, the market value engine 322, the market prices adjustment engine 312, and/or the financial transform engine 316 of FIG. 3, may be configured to be performed in part by an edge server or a device interoperating with an edge server. The device interoperating with the edge server, for example, may share processing functionality with the edge server via one or more APIs implemented by the processes.

The systems described herein may include one or more artificial intelligence (AI) neural networks for performing automated analysis of data. The AI neural networks, in some examples, can include a synaptic neural network, a deep neural network, a transformer neural network, and/or a generative adversarial network (GAN). The AI neural networks may be trained using one or more machine learning techniques and/or classifiers such as, in some examples, anomaly detection, clustering, and/or supervised and/or association. In one example, the AI neural networks may be developed and/or based on a bidirectional encoder representations for transformers (BERT) model by Google of Mountain View, CA.

The systems described herein may communicate with one or more foundational model systems (e.g., artificial intelligence neural networks). The foundational model system(s), in some examples, may be developed, trained, tuned, fine-tuned, and/or prompt engineered to evaluate data inputs such as the inputs described as being provided by the publication analyzing engine 124 of FIG. 1A. The foundational model systems, in some examples, may include or be based off of the generative pre-trained transformer (GPT) models available via the OpenAI platform by OpenAI of San Francisco, CA (e.g., GPT-3, GPT-3.5, and/or GPT-4) and/or the generative AI models available through Azure OpenAI or Vertex AI by Google of Mountain View, CA (e.g., PaLM 2).

Certain foundational models may be fine-tuned as AI models trained for performing particular tasks required by the systems described herein. Training material, for example, may be submitted to certain foundational models to adjust the training of the foundational model for performing types of analyses described herein.

Multiple foundational model systems may be applied by the systems and methods described herein depending on context. The context, for example, may include type(s) of data, type(s) of response output desired (e.g., at least one answer, at least one answer plus an explanation regarding the reasoning that lead to the answer(s), etc.). In another example, the context can include user-based context such as demographic information, entity information, and/or product information. In some embodiments, a single foundational model system may be dynamically adapted to different forms of analyses requested by the systems and methods described herein using prompt engineering.

While certain embodiments have been described, these embodiments have been presented by way of example only and are not intended to limit the scope of the present disclosure. Indeed, the novel methods, apparatuses and systems described herein can be embodied in a variety of other forms; further, various omissions, substitutions and/or changes in the form of the methods, apparatuses and systems described herein can be made without departing from the spirit of the present disclosure. The accompanying claims and their equivalents are intended to cover such forms or modifications as would fall within the scope and spirit of the present disclosure.

What is claimed is:

1. A system for automatically collating information from a corpus of publications regarding effects of an emerging risk on at least one organization, the system comprising:
a risk event taxonomy comprising terms and definitions related to at least one emerging risk event type;
a non-transitory computer-readable data store configured to organize unstructured publication files according to a relational data structure, the relational data structure comprising
an event data structure comprising an organization identifier, a start date, and a geographic region, and
a financial snapshot data structure configured to link to the event data structure by the organization identifier; and
at least one artificial intelligence (AI) model fine-tuned to label contents of unstructured documents according to the risk event taxonomy; and
processing circuitry configured to
using an organization name, capture a plurality of digital resources from one or more publication sources,
arrange the plurality of digital resources in the non-transitory computer-readable data store according to title, body text, and the organization identifier corresponding to the organization name,
for each respective digital resource of at least a portion of the plurality of digital resources, transform at least a portion of text of the respective digital resource into a respective subset of vector-formatted text portions of a plurality of vector-formatted text portions,
store, to an event vector database, the plurality of vector-formatted text portions, wherein at least a portion of the plurality of vector-formatted text portions are arranged in the event vector database by named-entity values encoded within the portion of the plurality of vector-formatted text portions,
prompt the at least one AI model to extract a set of emerging risk event details from the plurality of vector-formatted text portions of the plurality of digital resources, each emerging risk event detail of the set of emerging risk event details corresponding to a definition of the risk event taxonomy, wherein the set of emerging risk event details comprise the start date, the geographic region, and a descriptive headline,
compare the set of emerging risk event details across the portion of the plurality of digital resources to one or more monitored risk events to relate the plurality of digital resources with a new emerging risk event or a preexisting emerging risk event,
responsive to relating the plurality of digital resources with the new emerging risk event, store, to the event data structure, the set of emerging risk event details,
responsive to relating the plurality of digital resources with the new emerging risk event, capture, from one or more financial data sources, an initial valuation for an organization described by the organization name, wherein the initial valuation is associated with a first date,
store the initial valuation to the financial snapshot data structure,
multiple days after capturing the initial valuation, collect at least one additional valuation of the organization on a second date and store to the financial snapshot data structure,
analyze the at least one additional valuation in view of the initial valuation to determine an organizational financial trend over a post-event time period spanning from the first date to the second date,
using at least one beginning market snapshot of the first date and at least one ending market snapshot of the second date, determine at least one comparison financial trend over the post-event time period,
adjust the organizational financial trend in view of the at least one comparison financial trend, and
analyze the adjusted organizational financial trend to identify any evidence of a secondary risk financial impact to the organization due to a secondary risk.

2. The system of claim 1, wherein the processing circuitry is further configured to:
receive organization information for performing an emerging risk publication analysis; and
normalize the organization information to determine the organization name.

3. The system of claim 1, wherein a plurality of emerging risk event types comprises the at least one emerging risk event type of the risk event taxonomy, the plurality of emerging risk event types comprising two or more of a physical disruption risk, a digital disruption risk, a workforce volatility risk, a financial volatility risk, or a regulatory risk.

4. The system of claim 1, wherein the set of emerging risk event details comprises at least one of a dollar amount, a product, or a person of leadership within the organization identified by the organization name.

5. The system of claim 1, wherein the set of emerging risk event details comprise at least one of an impact value, one or more product names, or a geographic expanse of impact.

6. The system of claim 1, wherein the financial snapshot data structure comprises a stock price, a stock market index price, and a capture date.

7. The system of claim 1, wherein the secondary risk is one of a reputational risk or a supply chain risk.

8. The system of claim 1, wherein:
each respective digital resource of the plurality of digital resources comprises a metadata portion; and
the processing circuitry is further configured to filter the metadata portions of the plurality of digital resources by at least one filter criterion.

9. The system of claim 1, wherein the processing circuitry is further configured to, responsive to relating the plurality of digital resources with the preexisting emerging risk event:
compare the set of emerging risk event details with one or more previously captured emerging risk event details to identify one or more adjusted emerging risk event details; and
responsive to identifying the one or more adjusted emerging risk event details, update the set of emerging risk event details of the event data structure with the one or more adjusted emerging risk event details.

10. A system for monitoring secondary impact to an organization due to a risk event, the system comprising:
an emerging risk taxonomy comprising terms and definitions related to at least one emerging risk event type;
a non-transitory computer-readable data store configured to store event data for a plurality of monitored emerging risk events; and
one or more processors configured to perform operations comprising
gathering a plurality of publications relevant to an organization,
analyzing text contents of each publication of the plurality of publications in view of the emerging risk taxonomy to identify, for each publication of the plurality of publications, a plurality of event data values, wherein
the plurality of event data values comprises one or more respective start dates and one or more respective locations,
grouping subsets of the plurality of publications into a set of publication clusters, wherein each respective publication cluster of the set of publication clusters belongs to a same risk event of a set of risk events,
for each respective risk event of the set of risk events,
initiating entity valuation monitoring to track potential secondary risk impact,
wherein the entity valuation monitoring comprises
using the organization, collecting an initial financial snapshot using on a first date,
multiple days after the initial financial snapshot, collecting at least one additional financial snapshot of the organization on a second date,
analyzing the at least one additional financial snapshot in view of the initial financial snapshot to determine an organizational financial trend over a post-event time period spanning from the first date to the second date,
using at least one beginning market snapshot of the first date and at least one ending market snapshot of the second date, determining at least one comparison financial trend over the post-event time period,
adjusting the organizational financial trend in view of the at least one comparison financial trend, and
analyzing the adjusted organizational financial trend to identify any evidence of a secondary risk financial impact to the organization due to a secondary risk.

11. The system of claim 10, wherein the at least one emerging risk event type comprises one or more of a physical disruption risk, a digital disruption risk, a workforce volatility risk, a financial volatility risk, or a regulatory risk.

12. The system of claim 10, wherein the secondary risk is one of a reputational risk or a supply chain risk.

13. The system of claim 10, wherein the plurality of event data values further comprises one or more dates.

14. The system of claim 10, wherein the one or more processors are further configured to perform operations comprising, for each respective publication cluster of the set of publication clusters, using the plurality of event data values, review the plurality of monitored emerging risk events for a matching risk event, wherein
upon failing to identify the matching risk event, the plurality of event data values of the respective publication cluster are added as a new monitored emerging risk event of the plurality of monitored emerging risk events; and
upon identifying the matching risk event, the plurality of event data values are merged with a second plurality of risk data values of the matching risk event of the plurality of monitored emerging risk events.

15. The system of claim 10, wherein the one or more processors are further configured to, prior to initiating the entity valuation monitoring:
based at least in part of a count of publications in a respective publication cluster of the set of publication clusters corresponding to the respective risk event, quantify a publicity level for the respective risk event; and
based at least in part on the publicity level, determine a likelihood of reputational risk,
for each respective risk event of the set of risk events having the likelihood of reputational risk at or above a threshold level;
wherein the entity valuation monitoring is initiated responsive to determining the likelihood of reputational risk is at or above a threshold level.

16. The system of claim 10, wherein the at least one comparison financial trend comprises a market value trend using an industry of the organization.

17. The system of claim 10, wherein
the non-transitory computer-readable data store is configured to organize the plurality of event data values according to a relational data structure, the relational data structure comprising
an event data structure comprising an organization identifier, a start date, and a geographic region, and
a financial snapshot data structure configured to link to the event data structure by the organization identifier; and
the operations further comprise storing the initial financial snapshot to the financial snapshot data structure.

18. The system of claim 17, wherein the relational data structure further comprises an entity data structure comprising the organization identifier and at least one industry.

19. The system of claim 17, wherein the financial snapshot data structure comprises at least one stock price.

20. The system of claim 10, wherein analyzing text contents of each publication of the plurality of publications in view of the emerging risk taxonomy comprises:
storing, to an event vector database, a plurality of vector-formatted text portions of each publication of the plurality of publications; and
prompting at least one artificial intelligence network to extract the plurality of event data values from the plurality of vector-formatted text portions of the plurality of publications, each event data value of the plurality of event data values corresponding to a definition of the emerging risk taxonomy.
